(19) United States
(12) Patent Application Publication
(10) Pub. No.: US 2017/0280304 A1
(43) Pub. Date: Sep. 28, 2017

(54) Terminal, Server, System, Management Method And Medium

(71) Applicant: CASIO COMPUTER CO., LTD., Shibuya-ku (JP)

(72) Inventor: Takeshi OKADA, Hamura-shi (JP)

(21) Appl. No.: 15/467,116

(22) Filed: Mar. 23, 2017

(30) Foreign Application Priority Data
Mar. 24, 2016 (JP) 2016-060011
Sep. 23, 2016 (JP) 2016-186163

(51) Int. Cl. H04W 4/08; H04W 4/02; H04W 76/02; H04M 1/725

(52) U.S. Cl. CPC H04W 4/08; H04M 1/72522; H04W 4/023; H04W 76/021; H04W 76/023

(57) ABSTRACT

A terminal being connected in communication with a server, and exchanging information with other terminal, the terminal including a processor, wherein the processor executes: an identification information transmission processing of transmitting identification information of a user's terminal to the server; a grouping authorization information transmission processing of associating the identification information of the user's terminal with identification information of the other terminal on the server, and transmits grouping authorization information for allowing a plurality of terminals to be grouped; and a grouping cancellation processing of constantly providing users with an interface for transmitting cancellation of the association to the server, in a state where the identification information of the user's terminal is associated with the identification information of the other terminal on the server.

This application is based upon and claims the benefit of priority under 35 USC 119 of Japanese Patent Application No. 2016-060011 filed on Mar. 24, 2016 and Japanese Patent Application No. 2016-186163 filed on Sep. 23, 2016 the entire disclosure of which, including the description, claims, drawings, and abstract, is incorporated herein by reference in its entirety.

### BACKGROUND OF THE INVENTION

Field of the Invention

The present invention relates to a terminal, a server, a system, a management method, and a program.

Related Art

Heretofore, as disclosed in Japanese Unexamined Patent Application, Publication No. 2013-065241, a space sharing system has been available, in which the system detects nearby presence of preregistered friends, and creates a group with the user and the friends.

### SUMMARY OF THE INVENTION

A terminal being connected in communication with a server, and exchanging information with other terminal, the terminal including a processor, wherein the processor executes:

an identification information transmission processing of transmitting identification information of a user's terminal to the server;

a grouping authorization information transmission processing of transmitting grouping authorization information for associating the identification information of the user's terminal with identification information of the other terminal on the server, and allowing a plurality of terminals to be grouped; and

a grouping cancellation processing of constantly providing users with an interface for transmitting cancellation of the association to the server, in a state where the identification information of the user's terminal is associated with the identification information of the other terminal on the server.

A server being connected in communication with terminals, and managing information exchange with the terminals, the server including a processor, wherein the processor executes:

an information acquisition processing of acquiring each identification information of the terminals from the terminals via a communication function of the terminals;

a grouping processing of grouping the plurality of terminals by associating the identification information acquired by the information acquisition processing; and

a grouping cancellation processing, wherein in a case in which an instruction to cancel the association is received from one of the plurality of associated terminals via an association cancellation interface that is constantly provided to users, the grouping cancellation processing of cancelling the association of the plurality of terminals.

A system including:

a plurality of terminals having a communication function; and

a server being connected in communication with the terminals, and managing information exchange with the terminals,

wherein the terminals execute:

an information transmission processing of transmitting identification information of the user's terminal to the server;

a grouping cancellation information transmission processing of constantly providing users with an interface for transmitting cancellation of the association to the server, in a state where the identification information of the user's terminal is associated with the identification information of the other terminal on the server; and

wherein the server executes:

an information acquisition processing of acquiring each identification information of the terminals from the terminals via a communication function of the terminals;

a grouping processing of grouping the plurality of terminals by associating the identification information acquired by way of the information acquisition processing; and

a cancellation determination processing of determining whether cancellation of the association has been received from the terminals; and

a grouping cancellation processing, wherein in a case in which the cancellation determination processing determines that cancellation of the association has been received, the grouping cancellation processing cancels the association of the identification information corresponding to the terminal that has transmitted the cancellation of the association, among the plurality of identification information associated by way of the grouping processing.

A management method performed on a terminal being connected in communication with a server and sharing information with other terminal, the method comprising:

an identification information transmitting step of transmitting identification information of a user's terminal to the server;

a grouping authorization information transmitting step of transmitting grouping authorization information for allowing a plurality of terminals to be grouped by associating the identification information of the user's terminal and identification information of the other terminal on the server; and
a grouping cancellation step of constantly providing users with an interface for transmitting cancellation of the association to the server, in a state where the identification information of the user's terminal is associated with the identification information of the other terminal on the server.

A non-transitory computer-readable medium having a program recorded thereon for causing a computer to control a terminal being connected in communication with a server and sharing information with other terminal to function as:

an identification information transmission unit that transmits identification information of a user's terminal to the server;

a grouping authorization information transmission unit that transmits grouping authorization information for allowing a plurality of terminals to be grouped by associating the identification information of the user's terminal and identification information of the other terminal on the server; and

a grouping cancellation unit that constantly provides users with an interface for transmitting cancellation of the association to the server, in a state where the identification information of the user's terminal is associated with the identification information of the other terminal on the server.

### BRIEF DESCRIPTION OF THE DRAWINGS

FIG. 1 is a conceptual diagram for illustrating a group operation technique in the present embodiment;

FIG. 2 is a system configuration diagram illustrating a system configuration of a group operation system S according to an embodiment of the present invention;

FIG. 3 is a schematic diagram illustrating transition of a screen display of a parent mobile terminal 1A, from creating a group to dissolving the group;

FIG. 4 is a schematic diagram illustrating transition of a screen display of a child mobile terminal 1B, from joining a group to withdrawal from the group;

FIGS. 5A-5C are a schematic diagram illustrating a display example of a map screen;

FIG. 6 is a block diagram illustrating a hardware configuration of the mobile terminal 1 according to an embodiment of the present invention;

FIG. 7 is a block diagram illustrating a hardware configuration of a server 2 according to an embodiment of the present invention;

FIG. 8 is a functional block diagram illustrating a functional configuration for executing group operation processing, in relation to the functional configurations of the mobile terminal 1 of FIG. 6 and the server 2 of FIG. 7;

FIG. 9 is a flow diagram describing a flow of (parent-side) group operation processing executed by the parent mobile terminal 1A of FIG. 6 having the functional configuration of FIG. 8;

FIG. 10 is a flow diagram describing a flow of (child-side) group operation processing executed by the child mobile terminal 1B of FIG. 6 having the functional configuration of FIG. 8;

FIG. 11 is a flow diagram describing a flow of (server-side) group operation processing executed by the server 2 of FIG. 7 having the functional configuration of FIG. 8;

FIG. 12 is a schematic diagram illustrating a transition example of a screen display of the parent mobile terminal 1A, in relation to creation of a party;

FIG. 13 is a schematic diagram illustrating the entry status screen in detail;

FIG. 14 is a schematic block diagram illustrating a transition example of a screen display of the child mobile terminal 1B in relation to participation in a party;

FIG. 15 is a schematic diagram illustrating the entry status screen in detail;

FIG. 16 is a schematic block diagram for illustrating a map display after completing creation of a party;

FIG. 17 is a schematic diagram for illustrating functions to dissolve and leave a party;

FIG. 18 is a schematic diagram for illustrating functions to dissolve and leave a party; and

FIG. 19 is a schematic diagram illustrating a transition example of a screen display for sending a message.

### DETAILED DESCRIPTION OF THE INVENTION

Embodiments of the present invention will be explained with reference to the drawings.

An embodiment of the present invention is described hereinafter with reference to the drawings.

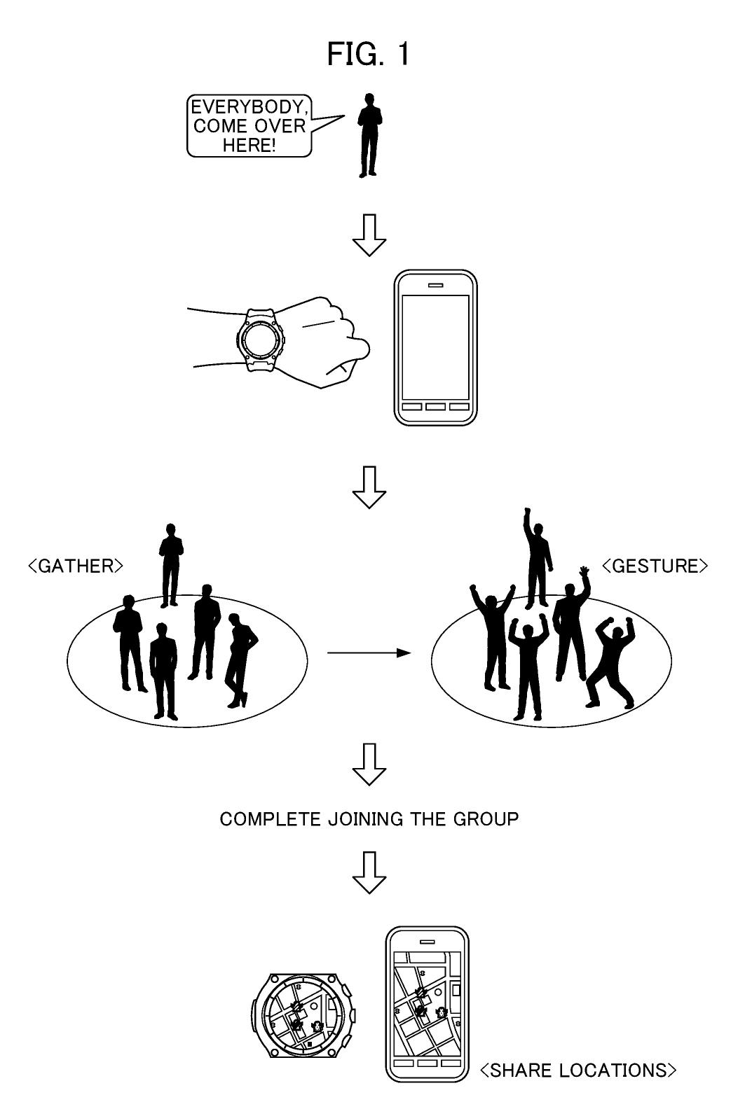

FIG. 1 is a conceptual diagram for illustrating a group operation technique in the present embodiment.

In the present embodiment, a plurality of mobile terminals 1 having a common application constitute a group, and each information of the mobile terminals 1 (in the present embodiment, each location) is shared by the group.

A group of the present embodiment is illustrated in FIG. 1, in which a user (parent), who wishes to create a group, calls for each mobile terminal 1 to join the group. Other users (children), who answered the call for joining, will gather at a place designated by the user (parent) who called for joining, and perform an action designated by the user (parent) (in the present embodiment, perform a gesture), thereby completing joining the group (group registration). Thereafter, locations of the members of the group will be mutually shared by the mobile terminals 1 belonging to the group.

Note that, hereinafter, the mobile terminal 1 of the user who creates a group is referred to as “the parent mobile terminal 1A”, and each of the other mobile terminals 1′ of the users who join the group is referred to as “the child mobile terminal 1B”.

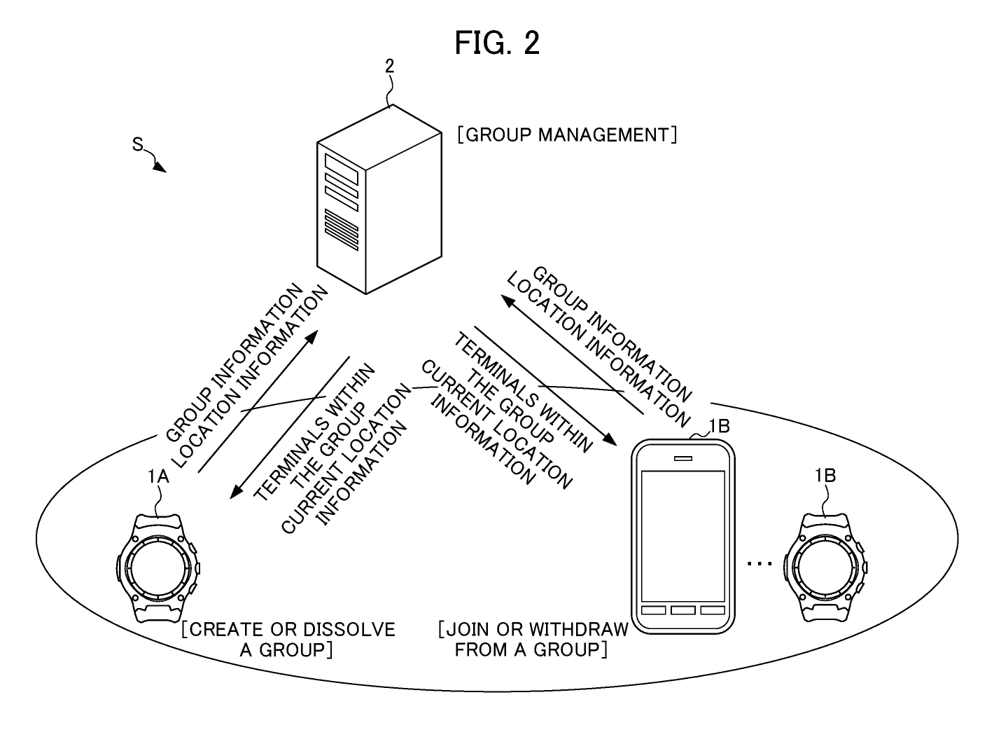

FIG. 2 is a system configuration diagram illustrating a system configuration of a group operation system S according to an embodiment of the present invention.

As illustrated in FIG. 2, the group operation system S includes the mobile terminal 1 (the parent mobile terminal 1A and the child mobile terminal 1B) and a server 2.

Namely, in the group operation system S, the server performs management (creation, dissolution, joining, withdrawal, and location sharing) of a group, to which the member mobile terminals 1 belong.

The mobile terminal 1 has a communication function to communicate with the server 2, a sensing function that can acquire the posture change and location of the user's terminal, and a display function that can display the locations of the user's terminal and the other terminals.

The server 2 has a communication function to communicate with the mobile terminals 1, a function to manage the creation/dissolution/joining/withdrawal of a group, and a function to cause the mobile terminals 1 of the group to share each other's location.

The parent mobile terminal 1A transmits at least information such as conditions for joining the group (hereinafter referred to as “group creation information”), and location information of the user's terminal used for sharing the location, to the server 2. In return, the server 2 distributes location information of the child mobile terminals 1B within the group, to the parent mobile terminal 1A.

Further, the child mobile terminal 1B transmits at least information required for joining the group (hereinafter referred to as “group joining information”) and location information of the user's terminal, to the server 2. In return, the server 2 distributes current location information of the other mobile terminals 1 within the group, to the child mobile terminal 1B. On the other hand, when a group is dissolved, the parent mobile terminal 1A transmits information for requesting dissolution of the group (hereinafter referred to as “group dissolution information”); and when a member withdraws from the group, the child mobile terminal 1B transmits information for requesting withdrawal from the group (hereinafter referred to as “group withdrawal information”). Group creation information, group joining information, group withdrawal information, group dissolution information, and information of a request from the parent mobile terminal 1A to close invitation to the group (hereinafter referred to as “group invitation closing information”) are hereinafter collectively referred to as “group information” as well.

Specifically, the group operation system S performs a group operation in the following steps.

(1) An intention to create a group is input on the parent mobile terminal 1A, and the parent mobile terminal 1A transmits this request as group creation information to the server 2.

The group creation information includes an intention to create a group, a location range that allows for joining the group, and a condition for joining the group (in the present embodiment, the condition is to perform a predetermined action, or more specifically, a predetermined gesture).

(2) Users who have the child mobile terminal 1B and wish to join the group gather at a place within the location range that allows for joining the group.

(3) The user of the child mobile terminal 1B provides his/her request to join the group, acquires a location to indicate his/her terminal being within the location range, and performs an action that is predesignated as a joining condition (in the present embodiment, a gesture). The child mobile terminal 1B transmits the group creation information, which includes the request to join the group, the location information, and the gesture information, to the server 2.

(4) In the case in which the gesture performed by the user having the child mobile terminal 1B is correct, the server 2 manages acceptance of the user to join the group. As a result, locations of the mobile terminals 1 joining the group are displayed on a map of the area, in each of the parent mobile terminals 1A and the child mobile terminal 1B.

(5) The parent mobile terminal 1A that has created a group can dissolve the group, and the child mobile terminal 1B that has joined the group can withdraw from the group. Once the child mobile terminal 1B withdraws from the group, it disappears from the map of the area, and its location will not be displayed thereafter.

Therefore, with the group operation system S, personal addresses, etc. of the parent mobile terminal 1A having created a group and the child mobile terminal 1B having joined the group will not be mutually acquired between the mobile terminals 1. Further, since a user can be registered by performing a predetermined gesture within a predetermined range, other users having the mobile terminals 1′ will not be identified, either. In other words, if the predetermined range is set up within a visible range, a group can be managed in a safe state where each user can recognize each other.

That is to say, with the group operation system S, since a user can join a group by performing a predetermined gesture within a predetermined location range, and once the parent mobile terminal 1A having created a group dissolves the group, or the child mobile terminal 1B having joined a group withdraws from the group, each of the mobile terminals 1 will no longer retain information of the other mobile terminals 1, and therefore cannot be traced or contacted thereafter; therefore, a group with a “one-time” relationship can be created. Further, for example, by providing a limitation on a place or time, such as a user withdrawing from a group upon leaving a predetermined location range, or a group being dissolved upon a predetermined time having elapsed, a sense of being “one-time” can be enhanced.

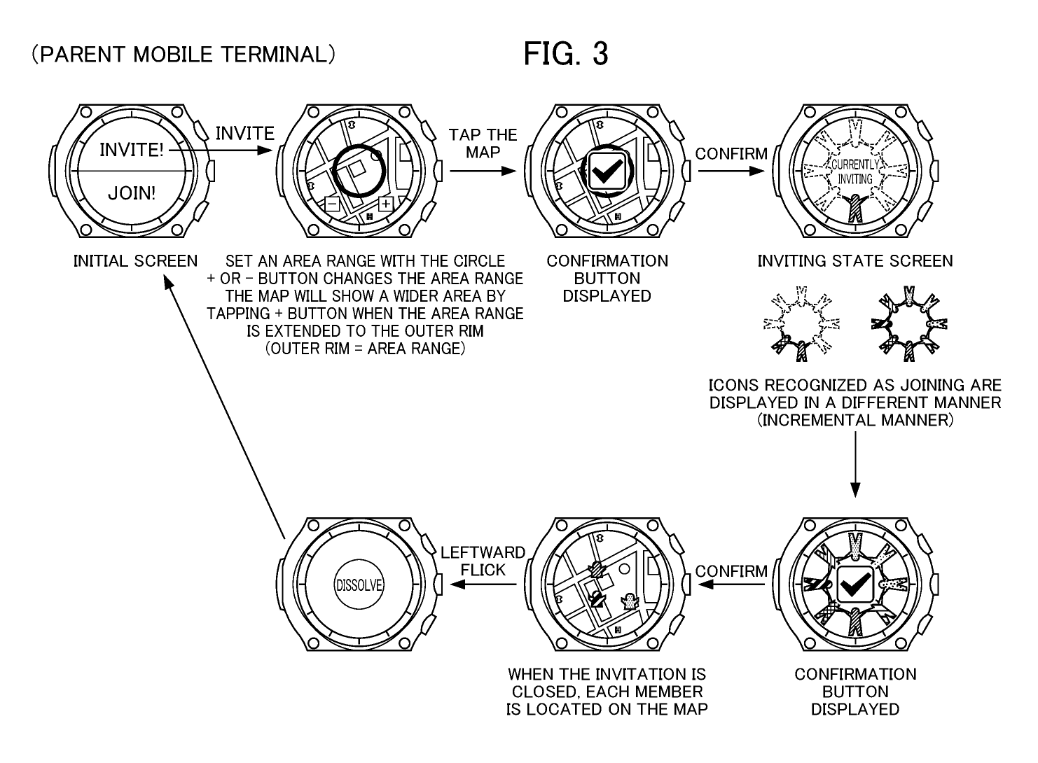

FIG. 3 is a schematic diagram illustrating transition of a screen display of the child mobile terminal 1B, from creating a group to dissolving the group.

As illustrated in the example of FIG. 3, by starting an application, a screen is displayed, on which “invite!” or “join!” can be selected (hereinafter referred to as “initial screen”). By selecting “invite!”, a group will be created, and the mobile terminal 1 will function as the parent mobile terminal 1A that hosts the group. On the other hand, by selecting “join!”, the user will join a group, and the mobile terminal 1 will function as the child mobile terminal 1B that joins the group. By selecting “invite!”, the screen transitions to a screen, on which an area range of the group can be determined. On the screen for determining an area range of the group, a frame indicating an area range is displayed on a map, on which a “+” or “−” button can be operated to change the size of the area range. Note that, by extending the area range towards the outer rim of the display screen, the map will show a wider area thereafter. Thereafter, by tapping the map, then tapping a confirmation button that appears, the area range will be determined. By determining the area range, the screen transitions to an inviting state screen. The inviting state screen displays an inviting state where members join or do not join. Note that the inviting state screen is configured to display human-shaped icons taking each other's hands in a circle, in which a human-shaped icon recognized as joining is displayed in a different manner. When recognized as joining, the human-shaped icon is displayed, for example, as colored. In addition, by tapping the inviting state screen, then tapping a confirmation button that appears, the invitation will be closed. Subsequently, the screen transitions to a map screen, and the locations of the current members are displayed on the map. In this example, the locations of the current members are displayed on the map, in a manner corresponding to the display of the human-shaped icons on the inviting state screen. Note that, in the case of adding a function to transmit and receive messages, the function may be configured to display a message in a speech balloon from the human-shaped icon corresponding to the message sender. Further, in the case of adding a status display function, the function may be configured such that a state of a human-shaped icon (for example, an emergency state, etc.) is changed correspondingly (for example, change in color or shape, or the like). On the map screen, by performing a predetermined operation (for example, a leftward flick), the screen transitions to a screen for determining dissolution of the group, and by tapping a “dissolve” button, the group will be dissolved. Subsequently, the screen transitions to the initial screen. In this manner, in the present embodiment, after completing the grouping, and while notification of the group user information such as a map is provided, an interface for dissolving the group is constantly provided. Therefore, a user is not forced to perform complicated operations such as starting a function to operate registration setup each time a group is dissolved.

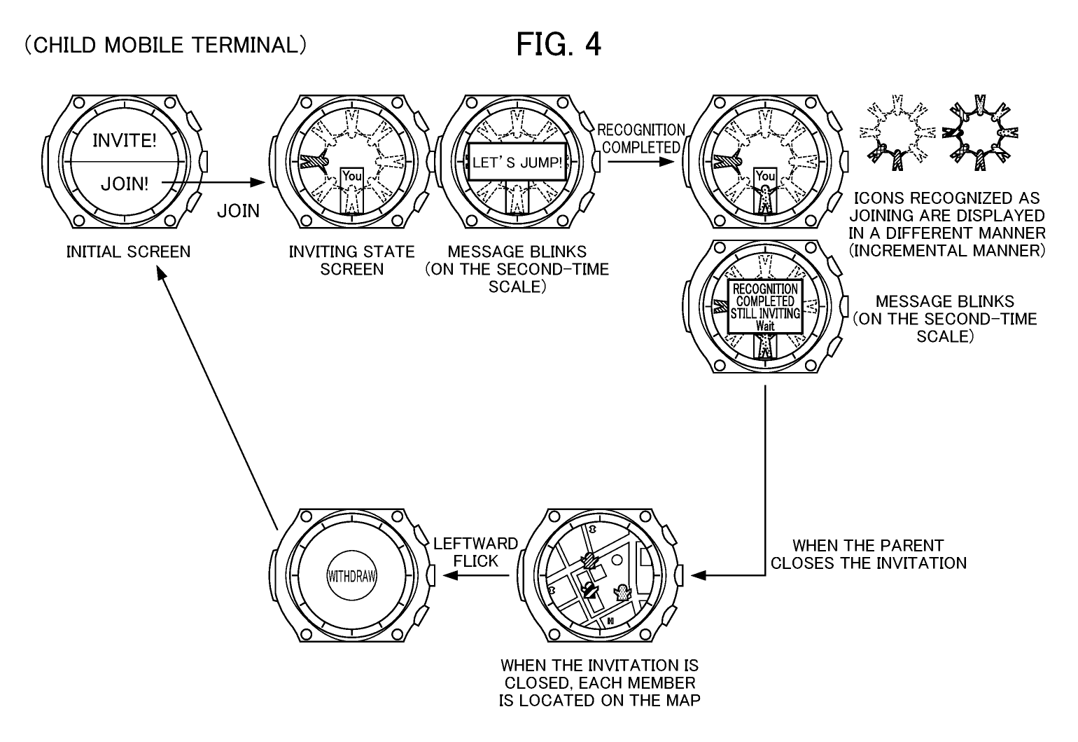

FIG. 4 is a schematic diagram illustrating transition of a screen display of the child mobile terminal 1B, from joining a group to withdrawal from the group.

As illustrated in the example of FIG. 4, when a user selects “join!” on the initial screen, the screen transitions to the inviting state screen, which in turn displays the user's own state within the group that the user has indicated his/her intention to join. The human-shaped icon that is framed in “You” in the inviting state screen illustrates the user's own state. Immediately after the screen transition, since the user has not yet joined the group, the display of the human-shaped icon remains unchanged. Subsequently, the screen displays a blinking message promoting the user to perform a predetermined action (for example, a gesture), which is a condition for joining. In this example, the screen displays a message “let's jump!” indicating the action. Note that an action performed by a user may serve as the predetermined action, and the predetermined action may be a gesture performed by a user himself/herself, may be an operation to tap the screen of the mobile terminal 1 five times in a row, or may be configured to be selected from a pull-down menu.

Subsequently, when the user performs a gesture in accordance with the message, the gesture is recognized, and the user joins the group.

When the user joins the group, the display of the human-shaped icon corresponding to the user is changed, and the screen displays a message indicating that the invitation is still open.

When the invitation is closed, the screen transitions to a map screen, and the locations of the current members are displayed on the map.

On the map screen, when the user performs a predetermined operation (for example, a leftward flick), the screen transitions to a screen for determining withdrawal from the group, and when the user taps the “withdraw” button, the user withdraws from the group. Subsequently, the screen transitions to the initial screen.

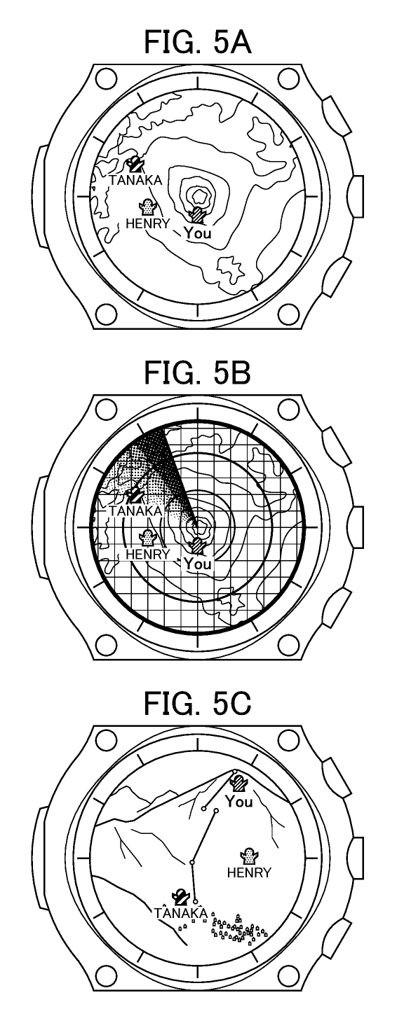

FIG. 5 is a schematic diagram illustrating a display example of a map screen.

As illustrated in the example of FIG. 5A, the map screen displays a map of a predetermined range centering around the location of the mobile terminal 1 that is displaying. In addition, users corresponding to the other mobile terminals 1′ are displayed at the corresponding locations in the map. In this example, “You” indicates the location of the user's terminal, and “Tanaka” and “Henry” respectively indicate the locations of the other mobile terminals 1′, of which nicknames have been registered in advance. Note that the human-shaped icons can also be freely set up in an arbitrary manner.

As illustrated in the example of FIG. 5B, radar display is performed at predetermined timing. The radar display displays the current locations of the other mobile terminal 1′ searched for afresh, and displays a predetermined range index centering around the user's terminal. By referring to the range index centering around the user's terminal as illustrated by the concentric circles and scale in the diagram, the user can also identify the distance relationship as well as the positional relationship with the other mobile terminal 1′. A distance indicated by the range index may be, for example, settable at an arbitrary distance such as 100 m, or may be variable depending on the distance between the mobile terminals 1 of the members.

Note that the map screen may be configured to continue displaying for a predetermined time period (for example, one minute), and subsequently transition to a background screen such as clock display. In such a case, a map screen may be displayed each time data is distributed (information is updated) from the server 2.

Further, the map screen may be configured to switch between the normal map display (FIG. 5A) and the radar display (FIG. 5B) by a user's tap operation.

In addition, although the map screen is configured to display a planar map in the above-mentioned example, for example, as illustrated in FIG. 5C, the map screen may be configured to display a map from a viewpoint overlooking a predetermined range from the sky, such as a bird's-eye view. In this case, the user can further recognize a perpendicular distance perspective, which is difficult to perceive in the planar map. This effectively functions in a case such as, for example, indicating the locations of the members at a skiing area.

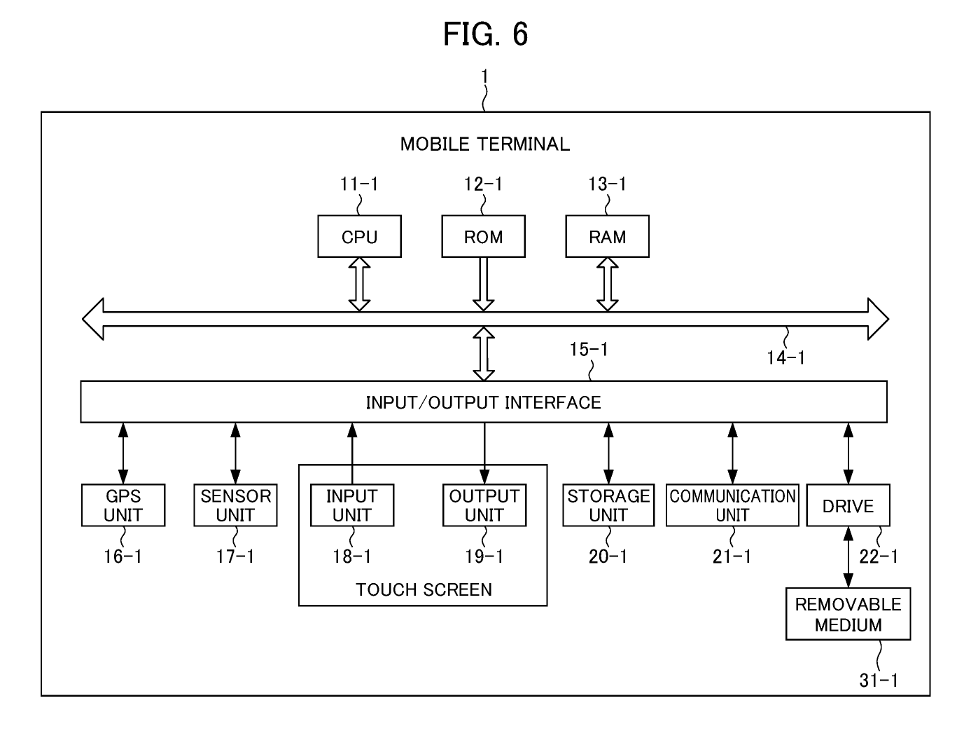

FIG. 6 is a block diagram illustrating a hardware configuration of the mobile terminal 1 according to an embodiment of the present invention. Note that a reference number of each hardware configuration of the mobile terminal 1 is hereinafter suffixed with “−1” to denote it belonging to the mobile terminal 1.

The mobile terminal 1 is configured as, for example, a smart watch or smartphone.

As illustrated in FIG. 6, the mobile terminal 1 includes a CPU (Central Processing Unit) 11-1, ROM (Read Only Memory) 12-1, RAM (Random Access Memory) 13-1, a bus 14-1, an input/output interface 15-1, a GPS unit 16-1, a sensor unit 17-1, an input unit 18-1, an output unit 19-1, a storage unit 20-1, a communication unit 21-1, and a drive 22-1.

The CPU 11-1 executes various processing in accordance with a program stored in the ROM 12-1 or a program loaded from the storage unit 20-1 to the RAM 13-1.

The RAM 13-1 also stores data and the like necessary for the CPU 11-1 to execute the various processing, as appropriate.

The CPU 11-1, the ROM 12-1 and the RAM 13-1 are connected to one another via the bus 14-1. The input/output interface 15-1 is also connected to the bus 14-1. The GPS unit 16-1, the sensor unit 17-1, the input unit 18-1, the output unit 19-1, the storage unit 20-1, the communication unit 21-1, and the drive 22-1 are connected to the input/output interface 15-1.

The GPS unit 16-1 receives GPS signals from a plurality of GPS satellites via a GPS receiving antenna (not illustrated). The CPU 11-1 acquires location information such as latitude/longitude and altitude indicating the current location of the device, based on the GPS signals received by way of the GPS unit 16-1.

The sensor unit 17-1 performs various sensing such as gyro, acceleration, earth magnetism and GPS, and outputs posture information and location information.

The input unit 18-1 is configured with various buttons, etc., and inputs a variety of information in accordance with a user's instruction operations.

The output unit 19-1 is configured with a display unit, a speaker, etc., and outputs images and sound.

In the present embodiment, the input unit 18-1 allowing for an input operation such as a touch or swipe is arranged as superimposed on the output unit 19-1 serving as a display for displaying images and icons, the entirety of which configures a touchscreen serving as an interface.

The storage unit 20-1 is configured with DRAM (Dynamic Random Access Memory) or the like, and stores data of various images.

The communication unit 21-1 controls communication with other devices (not illustrated) via a network including the Internet.

A removable medium 31-1 composed of a magnetic disk, an optical disk, a magneto-optical disk, semiconductor memory or the like is installed in the drive 22-1, as appropriate. Programs that are read via the drive 22-1 from the removable medium 31 are installed in the storage unit 20-1, as necessary. Similar to the storage unit 20-1, the removable medium 31 can also store a variety of data such as the image data stored in the storage unit 20-1.

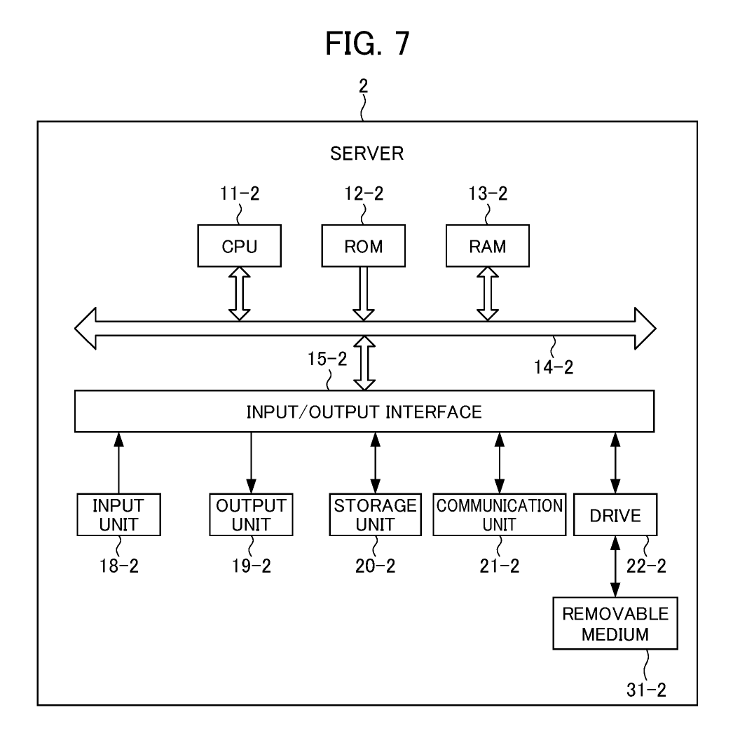

FIG. 7 is a block diagram illustrating a hardware configuration of the server 2 according to an embodiment of the present invention. Note that a reference number of each hardware configuration of the server 2 is hereinafter suffixed with “−2” to denote it belonging to the server 2.

The server 2 is configured as, for example, a PC (Personal Computer).

The server 2 has a hardware configuration ranging from a CPU 11-2 to an input/output interface 15-2, and an input unit 18-2 to a removable medium 31-2. Since the configuration ranging from the CPU 11-2 to the input/output interface 15-2 and the input unit 18-2 to the removable medium 31-2 is similar to the configuration ranging from the CPU 11-1 to the input/output interface 15-1 and the input unit 18-1 to the removable medium 31-1 of the mobile terminal 1, descriptions thereof are omitted herein.

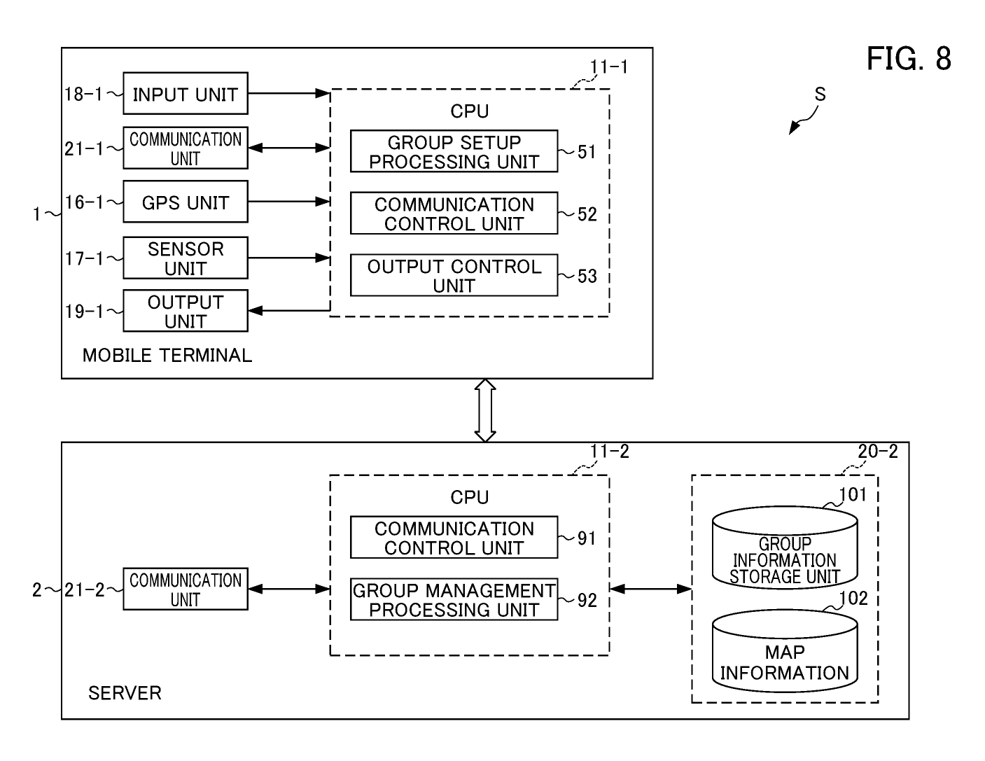

FIG. 8 is a functional block diagram illustrating a functional configuration for executing group operation processing, in relation to the functional configurations of the mobile terminal 1 of FIG. 6 and the server 2 of FIG. 7.

The group operation processing refers to a sequence of processing within a group that was instructed to be created by the parent mobile terminal 1A, in which the location information of the mobile terminals 1 of the group (the parent mobile terminal 1A and the child mobile terminals 1B) is shared by all of the mobile terminals 1 of the group (the parent mobile terminal 1A and the child mobile terminals 1B). In the present embodiment, the members share the locations with each other by belonging to the group.

In the case in which the group operation processing is executed on the mobile terminal 1, as illustrated in FIG. 8, a group setup processing unit 51, a communication control unit 52, and an output control unit 53 function in the CPU 11-1.

The group setup processing unit 51 performs various setups of a group, through an operation such as a user operation via the input unit 18-1.

Specifically, the group setup processing unit 51 executes processing such as starting or ending a location sharing application, executes processing involved with creating or dissolving a group in the case of the parent mobile terminal 1A, and executes processing involved with joining a group or withdrawing from a group in the case of the child mobile terminal 1B.

The communication control unit 52 controls the communication unit 21-1 to communicate with the server 2.

Specifically, the communication control unit 52 controls the communication unit 21-1 to transmit group creation information, group participation information, group withdrawal information, and group dissolution information to the server 2. Further, the communication control unit 52 controls the communication unit 21-1 to receive map information including the locations of the mobile terminals 1, distributed from the server 2.

The output control unit 53 controls the output unit 19-1 to display various screens.

Specifically, in the case of the parent mobile terminal 1A, the output control unit 53 controls the output unit 19-1 to display screens transitioning from the initial screen until the dissolution, as illustrated in the example of FIG. 3. Moreover, in the case of the child mobile terminal 1, the output control unit 53 controls the output unit 19-1 to display screens transitioning from the initial screen until the withdrawal, as illustrated in the example of FIG. 4. Further, the output control unit 53 controls the output unit 19-1 to display map information distributed from the server 2, in which each mobile terminal 1 is arranged in the map screen, as illustrated in the examples of FIGS. 5A and 5B.

In the case in which the group operation processing is executed on the server 2, as illustrated in FIG. 8, a communication control unit 91 and a group management processing unit 92 function in the CPU 11-2.

Further, a group information storage unit 101 and a map information storage unit 102 are set up in a region of the storage unit 20-2.

The group information storage unit 101 stores group information such as group ID associated with group creation information, group joining information, group creation information, and group joining information. In the present embodiment, the group creation information includes a location range of the group, a terminal application ID (hereinafter referred to as “APP_ID”), a type of gesture, and current location information. In addition, the group joining information includes APP_ID, current location information, and a type of gesture.

The map information storage unit 102 stores map information for providing the location of the terminal.

The communication control unit 91 controls the communication unit 21-2 to communicate with the mobile terminal 1.

Specifically, the communication control unit 91 controls the communication unit 21-2 to receive group creation information, group participation information, group withdrawal information, and group dissolution information, transmitted from the mobile terminal 1. Further, the communication control unit 52 controls the communication unit 21-2 to distribute map information including the locations of the mobile terminals 1, to the mobile terminals 1 within the group.

The group management processing unit 92 executes processing involved with management of the group, based on requests, etc. from the mobile terminals 1.

Specifically, based on the group creation information received from the mobile terminal 1, the group management processing unit 92 executes processing of creating a group and a group ID in association with each other, and storing such information into the group information storage unit 101. Moreover, based on the group joining information received from the mobile terminal 1, the group management processing unit 92 executes processing of determining the joining condition and allowing the mobile terminal 1 to join the group. Further, the group management processing unit 92 executes processing of creating map information for the mobile terminals 1 within the group, in which each mobile terminal 1 is arranged in the map. In addition, based on the group withdrawal information (APP_ID) received from the mobile terminal 1, the group management processing unit 92 executes processing of cancelling the association with the group ID stored in the group information storage unit 101, and allowing the mobile terminal 1 to withdraw from the group. Moreover, based on the dissolution information received from the mobile terminal 1, the group management processing unit 92 executes processing of deleting the group information stored in the group information storage unit 101, and allowing the group to dissolve.

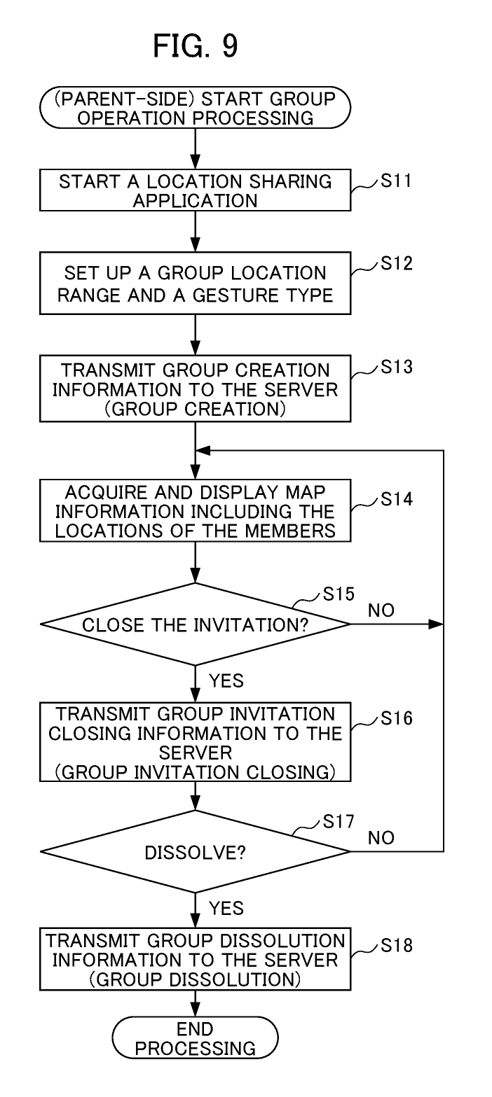

FIG. 9 is a flow diagram describing a flow of (parent-side) group operation processing executed by the parent mobile terminal 1A of FIG. 6 having the functional configuration of FIG. 8.

The (parent-side) group operation processing is started through a user operation on the input unit 18-1 to start the (parent-side) group operation processing.

In Step S11, the group setup processing unit 51 starts the location sharing application.

In Step S12, the group setup processing unit 51 sets up a group location range and a gesture type. As illustrated in the example of FIG. 3, a group location range is set up by designating a range on the map. A gesture type may be, for example, selected from a plurality of options (such as raising the terminal or jumping), or may be configured to be set up by identifying a gesture of the parent mobile terminal 1A.

In Step S13, the communication control unit 52 controls the communication unit 21-1 to transmit group creation information (group location range, APP_ID, location information, gesture type) to the server 2 (group creation). As a result, on the server 2, a group is created in association with a group ID corresponding to the group creation information.

In Step S14, the communication control unit 52 controls the communication unit 21-1 to acquire map information including the locations of the members distributed from the server 2. In addition, the output control unit 53 controls the output unit 19-1 to display a map including the locations of the members. The output unit 19-1 displays a screen, for example, such as displaying the mobile terminals 1 of the group around the user's terminal, as illustrated in FIG. 5A. Moreover, as illustrated in the example of FIG. 5B, the locations are searched afresh at predetermined timing, such that the mobile terminals 1 are rearranged at the current locations.

In Step S15, the group setup processing unit 51 determines whether the invitation to the group is closed. In the state where the invitation to the group is not closed, the output unit 19-1 displays, for example, the inviting state screen as illustrated in the example of FIG. 3. As members join the group, the display of the human-shaped icons changes in an incremental manner. This display is performed by automatically or manually switching from the screen displayed in Step S14 as illustrated in FIG. 5A or 5B.

In the case in which the invitation to the group is not closed, the determination in Step S15 is NO, and the processing returns to Step S14.

On the other hand, in the case in which the invitation to the group is closed, the determination in Step S15 is YES, and the processing advances to Step S16.

In Step S16, the communication control unit 52 controls the communication unit 21-1 to transmit the group invitation closing information for closing the invitation to the group, to the server 2 (group invitation closing). As a result, on the server 2, the invitation to the group is closed, without executing the processing involved with association with the group.

In Step S17, the group setup processing unit 51 determines whether a dissolving operation has been performed. In the present embodiment, when a dissolution button is tapped as illustrated in the example of FIG. 3, or the location sharing application is ended, it is determined that a dissolving operation has been performed.

In the case in which a dissolving operation has not been performed, the determination in Step S17 is NO, and the processing returns to Step S14.

On the other hand, in the case in which a dissolving operation has been performed, the determination in Step S17 is YES, and the processing advances to Step S18.

In Step S18, the communication control unit 52 controls the communication unit 21-1 to transmit the group dissolution information for requesting dissolution of the group, to the server 2 (group dissolution). As a result, the group information is deleted from the server 2, and the group is dissolved.

Subsequently, the (parent-side) group operation processing ends.

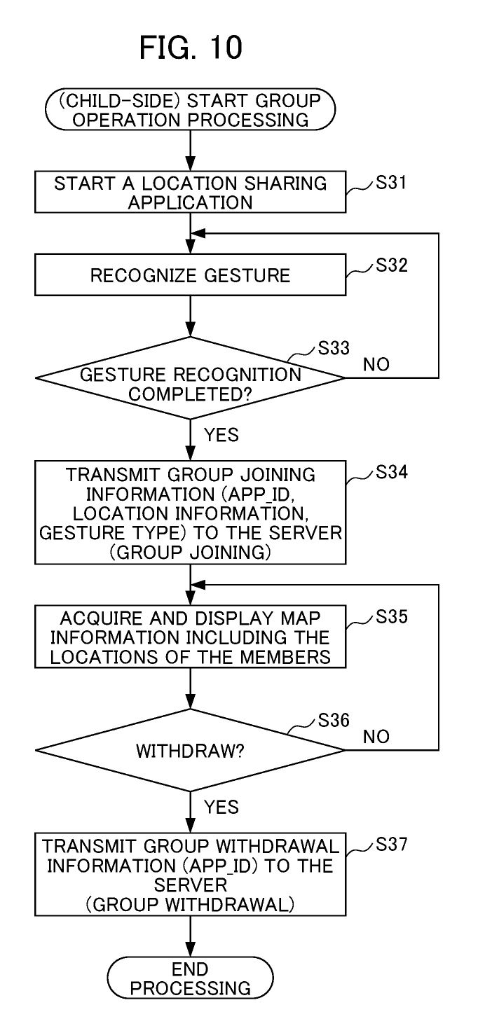

FIG. 10 is a flow diagram describing a flow of (child-side) group operation processing executed by the child mobile terminal 1B of FIG. 6 having the functional configuration of FIG. 8.

The (child-side) group operation processing is started through a user operation on the input unit 18-1 to start the (child-side) group operation processing.

In Step S31, the group setup processing unit 51 starts the location sharing application.

In Step S32, the group setup processing unit 51 recognizes a gesture, based on sensor information acquired from the sensor unit 17-1.

In Step S33, the group setup processing unit 51 determines whether a gesture has been recognized. As a result of recognizing a gesture, the group setup processing unit 51 identifies a type of the gesture.

In the case in which a gesture has not been recognized, the determination in Step S33 is NO, and the processing returns to Step S32.

On the other hand, in the case in which a gesture has been recognized, the determination in Step S33 is YES, and the processing advances to Step S34.

In Step S34, the communication control unit 52 controls the communication unit 21-1 to transmit group joining information (APP_ID, location information, gesture type) to the server 2 (group joining). As a result, on the server 2, in the case in which the location information falls within the group location range, and the gesture type is correct, the group ID is associated with the APP_ID, and a member joins the group.

In Step S35, the communication control unit 52 controls the communication unit 21-1 to acquire map information including the locations of the members distributed from the server 2. In addition, the output control unit 53 controls the output unit 19-1 to display a map including the locations of the members. The output unit 19-1 displays a screen, for example, such as displaying the mobile terminals 1 of the group around the user's terminal, as illustrated in FIG. 5A. Moreover, as illustrated in the example of FIG. 5B, the locations are searched afresh at predetermined timing, such that the mobile terminals 1 are rearranged at the current locations.

In Step S36, the group setup processing unit 51 determines whether a withdrawing operation has been performed. In the present embodiment, when a withdrawal button is tapped as illustrated in the example of FIG. 4, or the location sharing application is ended, it is determined that a withdrawing operation has been performed.

In the case in which a withdrawing operation has not been performed, the determination in Step S36 is NO, and the processing returns to Step S35.

On the other hand, in the case in which a withdrawing operation has been performed, the determination in Step S36 is YES, and the processing advances to Step S37.

In Step S37, the communication control unit 52 transmits group withdrawal information (APP_ID) to the server (withdrawal). As a result, the server 2 cancels the association between the member and the group ID, and the member withdraws from the group.

Subsequently, the (child-side) group operation processing ends.

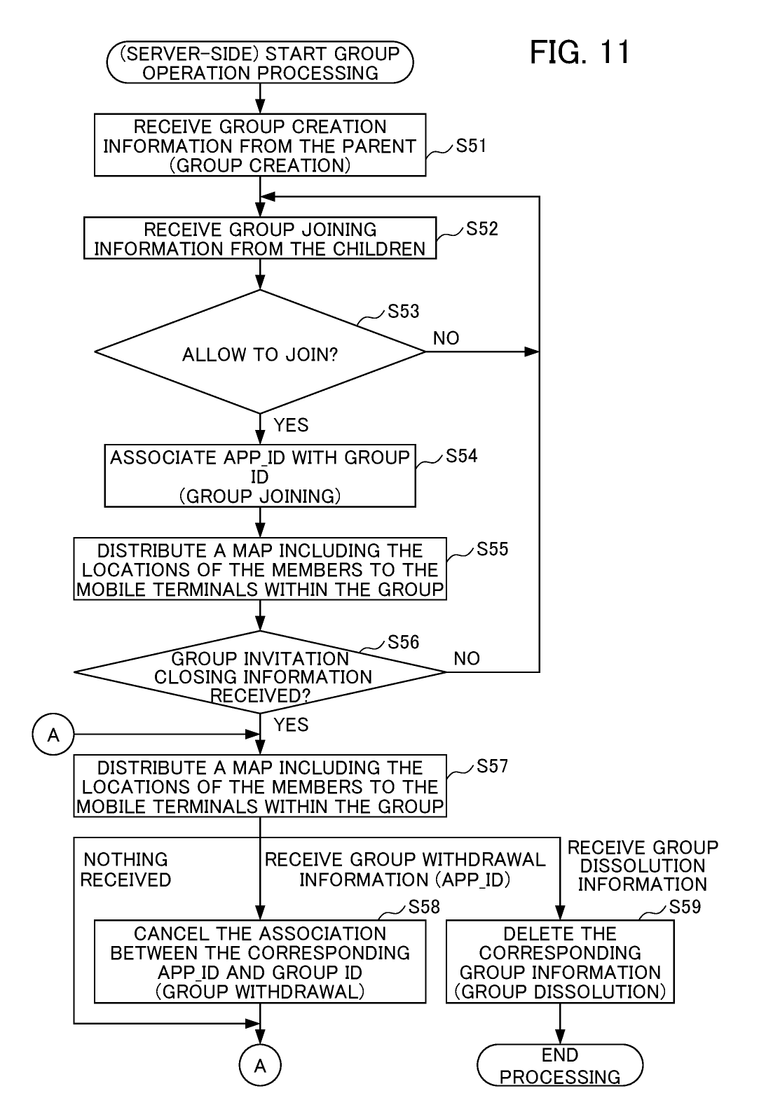

FIG. 11 is a flow diagram describing a flow of (server-side) group operation processing executed by the server 2 of FIG. 7 having the functional configuration of FIG. 8.

The (server-side) group operation processing is started through a user operation on the input unit 18-2 to start the (server-side) group operation processing.

In Step S51, the communication control unit 91 controls the communication unit 21-2 to receive group creation information from the parent mobile terminal 1A. The group creation information received is stored into the group information storage unit 101, and is associated with the corresponding group ID (group creation).

In Step S52, the communication control unit 91 controls the communication unit 21-2 to receive group joining information from the child mobile terminal 1B.

In Step S53, the group management processing unit 92 determines whether the child mobile terminal 1B is allowed to join the group. In the case in which the location information falls within the group location range, and the type of gesture is correct, the child mobile terminal 1B is allowed to join the group.

In the case in which the child mobile terminal 1B is not allowed to join the group, the determination in Step S53 is NO, and the processing returns to Step S52.

On the other hand, in the case in which the child mobile terminal 1B is allowed to join the group, the determination in Step S53 is YES, and the processing advances to Step S54.

In Step S54, the group management processing unit associates the APP_ID with group ID in the group information storage unit 101 (group joining).

In Step S55, the communication control unit 91 controls the communication unit 21-2 to distribute a map including the locations of the members to the mobile terminals 1 within the group, including the parent mobile terminal 1A and the child mobile terminal 1B. When distributing the map, an icon image displaying each mobile terminal 1 is generated at a location corresponding to the location information of the mobile terminal 1, on the map stored in the map information storage unit 102.

In Step S56, the communication control unit 91 determines whether group invitation closing information has been received.

In the case in which group invitation closing information has not been received, the determination in Step S56 is NO, and the processing returns to Step S52.

On the other hand, in the case in which group invitation closing information has been received, the determination in Step S56 is YES, and the processing advances to Step S57.

In Step S57, the communication control unit 91 controls the communication unit 21-2 to distribute a map including the locations of the members to the mobile terminals 1 within the group, including the parent mobile terminal 1A and the child mobile terminal 1B. When distributing the map, an icon image displaying each mobile terminal 1 is generated at a location corresponding to the location information of the mobile terminal 1, on the map stored in the map information storage unit 102.

In Step S58, in the case in which group withdrawal information is received from the child mobile terminal 1B, the group management processing unit 92 cancels the association between the relevant APP_ID and the group ID (group withdrawal).

In Step S59, in the case in which dissolution information is received from the parent mobile terminal 1A, the group management processing unit 92 deletes the relevant group information (group dissolution). On the other hand, in the case in which nothing is received from the parent mobile terminal 1A and the child mobile terminal 1B, the processing returns to Step S57.

Subsequently, the (server-side) group operation processing ends.

When performing an outdoor activity, in some cases, members who have gathered at the place on the day may wish to temporarily share the location information.

Existing information sharing services in general, such as SNS (Social Networking Services), have the drawbacks as follows. A user must register with a group in advance, which is troublesome. A user may not want even his/her close family members to know his/her own location information in many cases. After registering with a group, a user must set up each time whether to allow his/her location information to be shared, which is also troublesome.

Some users do not wish to share information in everyday life, but may wish to temporarily share information in a simple and convenient manner, which is in demand. In line with this, the group operation system S is configured to allow the mobile terminals 1 (or persons) within a specific area range to register with a group, based on the location information.

However, since a non-involved person and/or a spoofed member may exist within the area range, a mechanism for identifying a person as a member located within the area range is required.

The group operation system S is configured to allow for group registration by combining location information for determining a person to exist within an area range, and predetermined specific information for determining a person to be a member (in the present embodiment, gesture information).

As a result, with the group operation system S, a person who exists within a specific area range and has performed the correct gesture is “recognized as a member”, and can be readily and immediately registered with a group. Since the condition for recognizing a person as a member is being present within an area range and performing a gesture, a mechanism without security information leakage, even without the need to know the person's name, can be provided in an easy, casual, simple and prompt manner.

Moreover, in the information sharing such as SNS as described above, once a user is registered with a group, the user cannot cancel the grouping or withdraw from the group with a simple operation. In contrast, since the present invention can constantly provide the user with the interface for transmitting a request for cancellation of association with the mobile terminal 1 to the server 2, the user can easily cancel the group or withdraw from the group; as such, one-time and temporary grouping is realized.

The following are examples of the scenes where the group operation system S is utilized.

The group operation system S effectively functions in outdoor activities, in which users with different “ages”, “skills” and “physical strengths” frequently behave at different paces.

For example, in cycling, trail running, running, camping, fishing, skiing and snowboarding, an activity will be individually started, and once started, an individual behavior will be performed.

Examples of starting an individual activity]
“I will start fishing around xxxx from about 5:00”. (If time allows, let's fish together.) (fishing)
“I will camp solo at yyyy camping area from the day ˜.” (If time allows, let's camp together.) (camping)
“Since I will ski/snowboard first thing in the morning, call me up when you get up.” (skiing/snowboarding)
“I will start surfing before you at the usual spot. (If time allows, let's surf together.) (surfing)

### [Examples of an Individual Behavior After Starting an Activity]

“I will go ahead. I will be waiting for you at the convenience store near the xxxx bridge.” (cycling)
“I will go ahead. I will be waiting for you at the tea house.” (trail running)
“I will go ahead. I will be waiting for you at the goal.” (running)
“I will take the hiking course over there.” (camping)
“I will attack the fishing point over there. I will be back around noon.” (fishing)
“I will take this course. Let's get together at the lift” (skiing/snowboarding)

Since the users act separately, the users are interested in what and where the other members are doing, which in turn generate demand for utilizing the group operation system S.

For example, in the case of cycling, users gather at a meeting spot, create a group, and start cycling individually. Subsequently, since a gap among the users will gradually increase, the users will need to share information (locations, conditions, messages). Subsequently, when the users arrive at the goal, the group will be dissolved on the spot.

Therefore, (1) the members can readily know where the other members are during the activity. Once an activity starts, the members can know each other's location. Once the activity ends, the members can no longer know each other's location.

(2) The members can readily know conditions of the other members during the activity. Once an activity starts, the members can know each other's condition. Once the activity ends, the members can no longer know each other's condition.

[Examples of Knowing a Condition of Another Member]
He/she is walking.
He/she is running.
He/she is not moving.
He/she fell.
He/she is driving at xx km/h.
He/she is catching xx fish.
He/she is approaching (within zz m).
He/she is moving away (from yy m).

(3) Users can readily share membership with persons whom the users meet for the first time.

In outdoor activities, a stranger such as “friend of friend” may often join, and can readily be a member on the spot.

(4) Privacy other than the activity information is protected.

The users can maintain a relationship such as not wishing to know each other except for the activity, or not wishing to encroach on each other's life.

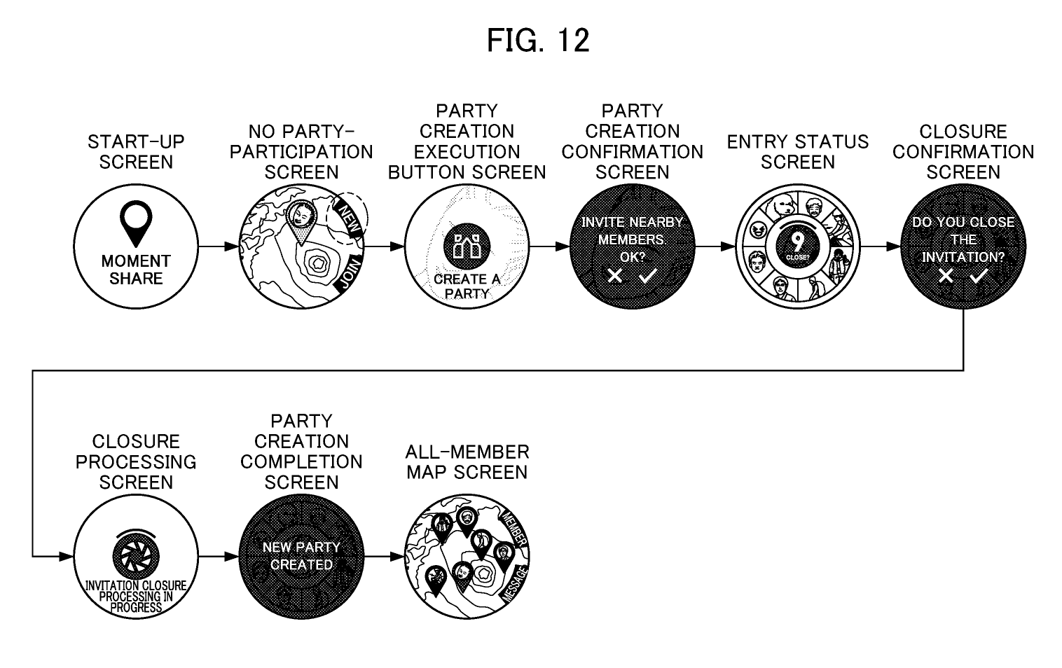

FIG. 12 is a schematic diagram illustrating another transition example of a screen display of the parent mobile terminal 1A, in relation to creation of a party that serves as a group. Note that the present embodiment may be configured to operate with a beacon. In the case of operating with a beacon, a beacon ID of the user's terminal and a corresponding unique ID of the user's terminal are registered in association with each other on the server 2; and each time a beacon is received, a beacon ID of the beacon received is uploaded to the server 2. The server 2 determines whether a unique ID corresponding to the beacon ID has been registered; and in the case in which the corresponding unique ID has been registered, the server 2 transmits information of the mobile terminal 1 corresponding to the received beacon ID to the mobile terminal 1 that has uploaded the beacon ID. When the mobile terminal 1 has received the information of the mobile terminal 1 corresponding to the beacon ID received from the server 2, the mobile terminal 1 corresponding to the beacon ID received can be configured as a mobile terminal 1 having the function involved with a party, so as to execute various processing such as creation, dissolution, participation, and withdrawal in relation to a party. Transmission and reception of a beacon ensures that the devices are within a communication range; and the configuration of communication via the server 2 allows various processing to be executed without directly exchanging private information such as individual identification information between the mobile terminals 1.

When a party is created, as illustrated in the example of FIG. 12, in the state in which the user has not participated yet in a party, the application start-up screen transitions to a no party-participation screen. The no party-participation screen displays a preregistered icon for identifying the user himself/herself at the location of the user's terminal, on a topographical map of the surrounding environment. The no party-participation screen displays a “NEW” button for creating a party as a parent, and a “JOIN” button for participating in another party.

When the “NEW” button is tapped in order to create a party, the screen transitions to a party creation execution button screen. The party creation execution button screen displays an execution button for creating a party, against the background of the icon image. By tapping the execution button for creating a party, creation of a party is confirmed, a beacon be transmitted, and subsequently, the screen transitions to an entry status screen indicating the status of participation by members as children.

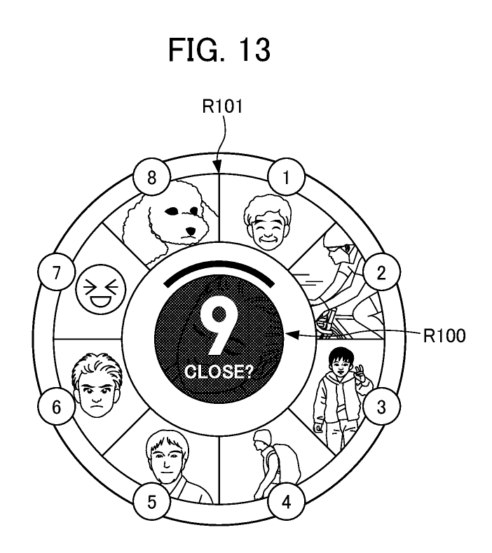

FIG. 13 is a schematic diagram illustrating the entry status screen in detail.

As illustrated in FIG. 13, the entry status screen displays the icons of applicants for the party (which may be icon images individually set up in advance by the applicants) in a surrounding region R101 equally divided around a region R100 indicating the number of applicants for the party. An icon image of the parent who created the party is displayed in the background of the region R100 indicating the number of participants in the party. In this example, since the number of applicants is eight (8), the region R100 indicating the number of participants in the party displays “9”, which is the number nine (9) indicating the total of the eight (8) applicants plus the person who created the party.

Further, the region R101 displays the icon images of the applicants equally divided in order of participation in a clockwise manner.

In addition, the region indicating the number of members also displays the word “CLOSE?”. By tapping this region, the party can be closed to new entries.

Note that the party can be configured to be automatically closed to new entries when a predetermined time period has elapsed. In this case, the arc immediately around the region indicating the number of members can be functionalized as a timer display indicating the remaining time until the closing.

Subsequently, by tapping the region indicating the number of members, the processing of closing the party ends, as illustrated in FIG. 12, and an all-member map screen is displayed, in which the locations of the participating members are indicated on the map. On the all-member map screen, the parent and children are displayed as distinguished in different color codes.

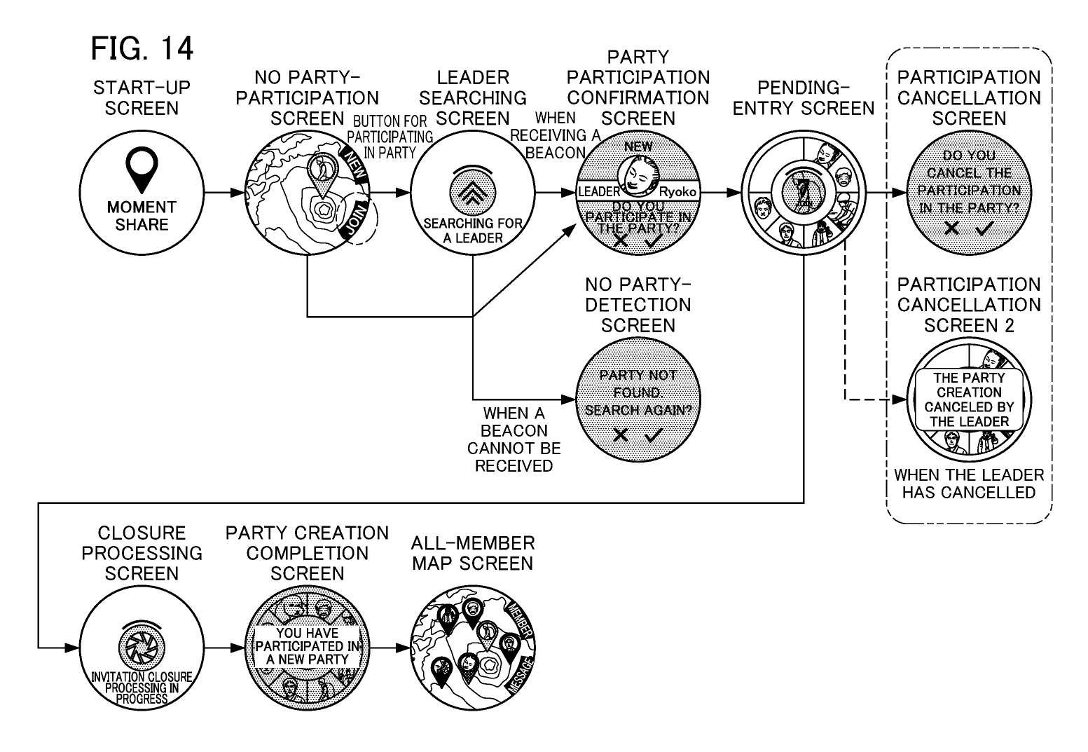

FIG. 14 is a schematic diagram illustrating another transition example of a screen display of the child mobile terminal 1B, in relation to participation in a party.

As illustrated in the example of FIG. 14, in order to participate in a party, in the state of not participating yet in a party, the application start-up screen transitions to the no party-participation screen, and the user taps a “JOIN” button for participating in the party as a child. Subsequently, the screen transitions to a leader searching screen, and when a beacon is received from a parent, the screen transitions to a party participation confirmation screen, in which the name and icon of the parent are displayed. When an interest in participation in the party is expressed, the screen transitions to a pending-entry screen. Note that, when a beacon is not received, the screen transitions to a screen of searching for a leader afresh. The screen of searching for a leader afresh displays a button for confirming an intention of searching afresh, and advice for receiving a beacon, such as “try again by moving close to a leader”.

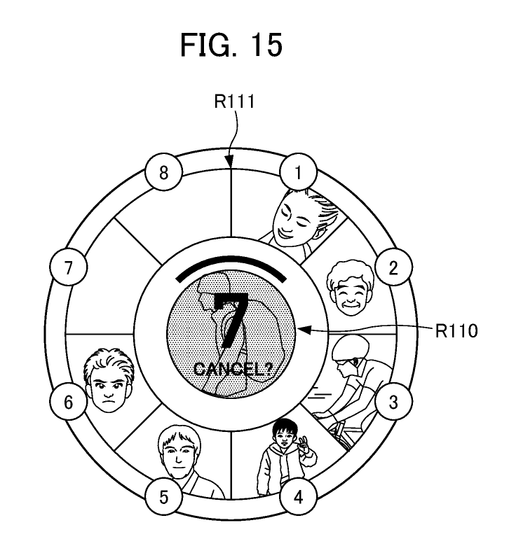

FIG. 15 is a schematic diagram illustrating the entry status screen in detail.

As illustrated in FIG. 15, the entry status screen displays the icons of applicants for the party in a surrounding region R111 equally divided around a region R110 indicating the number of applicants for the party. An icon image of the user's terminal is displayed in the background of the region R110 indicating the number of participants in the party. In this example, since the number of applicants is six (6), the region R110 indicating the number of participants in the party displays “7”, which is the number seven (7) indicating the total number of members including the person who created the party.

Further, the region R111 displays the icon images of the applicants equally divided in order of participation in a clockwise manner, in which the parent is the first in order. In this example, since the number of applicants is eight (8) excluding the user himself/herself, the region R111 is divided into eight. Since two regions display no icon images, it is understood that there are six (6) applicants.

In addition, the region indicating the number of members displays the word “CANCEL?”. By tapping this region, the membership can be cancelled.

As illustrated in FIG. 14, in the case in which the parent cancels the creation of the party, the screen transition to a participation cancellation screen 2 that displays a message, “the party creation has been canceled by the leader”.

In the case in which the parent has not cancelled the creation of the party, creation of the party is completed, and the screen transitions to an all-member map screen.

The all-member map screen displays the locations of the participating members, together with the corresponding icon images, on the map. On the all-member map screen, the parent and children are displayed as distinguished in different color codes, and the user's terminal is displayed as distinguished from the other children in different color codes.

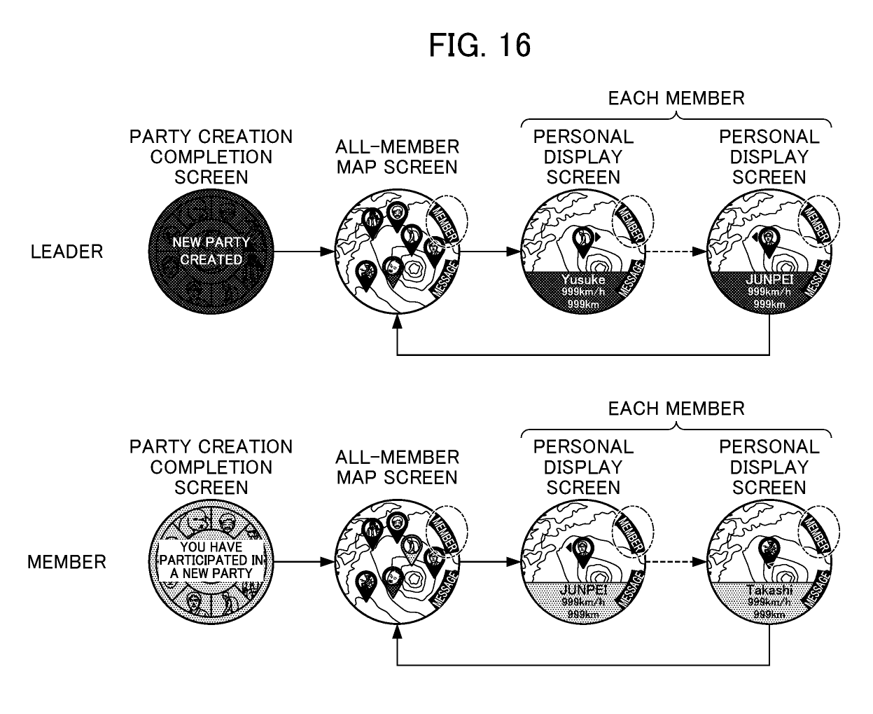

FIG. 16 is another schematic diagram for illustrating a map display after completing the creation of a party.

During the map display, the screens transition between an all-member map screen for displaying all of the members in the same screen, and a personal display screen for individually displaying each member. On the all-member map screen, by tapping a “MEMBER” button, the screen transitions to a personal display screen; and by further tapping the “MEMBER” button, the displayed member can be switched.

On the all-member map screen, the parent, the children and the user's terminal are displayed as distinguished in different color codes. Moreover, the map display is configured such that the user can select any one of a two-dimensional line map, an aerial photographic map, and a topographic map.

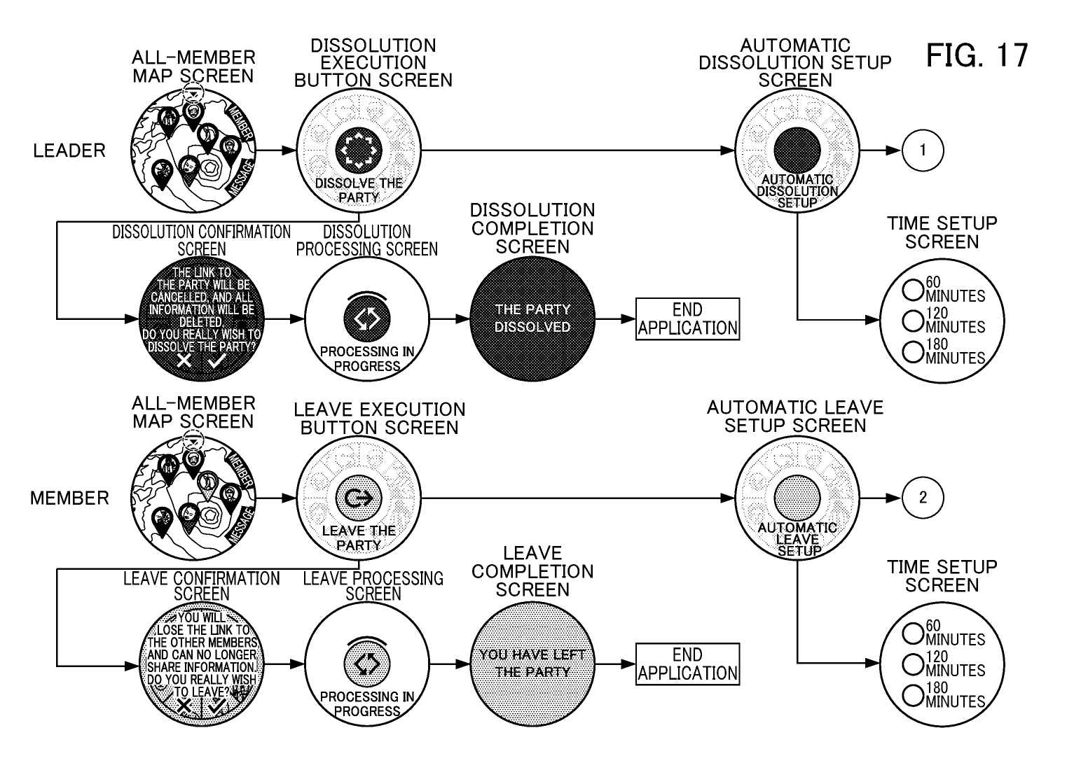

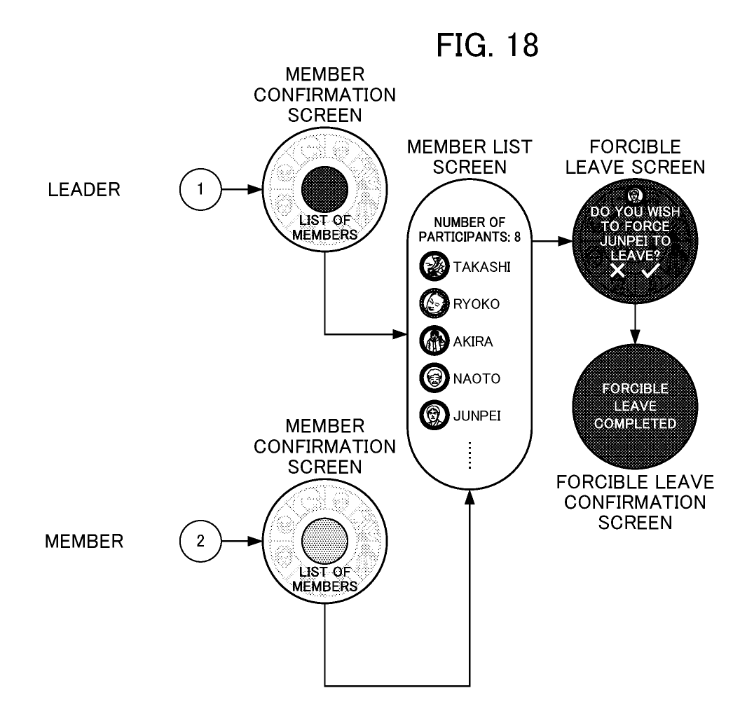

FIGS. 17 and 18 are schematic diagrams for illustrating functions to dissolve and leave a party.

As illustrated in FIG. 17, the all-member map screen of the parent mobile terminal 1A displays an icon for transitioning to a dissolution execution button screen for dissolving a party (in the present embodiment, a downward triangle icon). By performing a sliding operation to swipe this icon down the screen, the screen transitions to the dissolution execution button screen.

By tapping the dissolution execution button at the center of the dissolution execution button screen, the screen transitions to a dissolution confirmation screen. When dissolution is confirmed on the dissolution confirmation screen, the dissolution is completed, and the application ends. Further, the dissolution confirmation screen for confirming dissolution displays a message notifying the user of adverse effects of dissolution, “the link to the party will be cancelled, and all information will be deleted”, and a message for confirming dissolution, “do you really wish to dissolve the party?”

In addition, by swiping the dissolution execution button screen in a predetermined direction, the screen can transition to a previous or next screen, and as illustrated in FIG. 17, the dissolution execution button screen can transition to an automatic dissolution setup screen.

The user can set up automatic dissolution on the automatic dissolution setup screen. In the case of setting up automatic dissolution, the screen transitions to a time setup screen, on which the user can set up the time for automatic dissolution. In the present embodiment, a party can be set up to dissolve at any time limit of 60 minutes, 120 minutes, or 180 minutes after creating the party, in which the party will automatically dissolve after the elapse of the time limit.

Note that, as the function corresponding to the function to dissolve a party and the function to set up automatic dissolution, the child mobile terminal 1B has a leave function to leave a party, and an automatic leave function to automatically leave a party when a predetermined period of time has elapsed.

By swiping the automatic dissolution setup screen, the screen transitions to a member confirmation screen. FIG. 18 illustrates an example thereof. The member confirmation screen can display the list of the members participating in the party, and the parent has the authority to force any member to leave the party. Note that a child member does not have the authority to force any other member to leave, but can only display the list or status of the members.

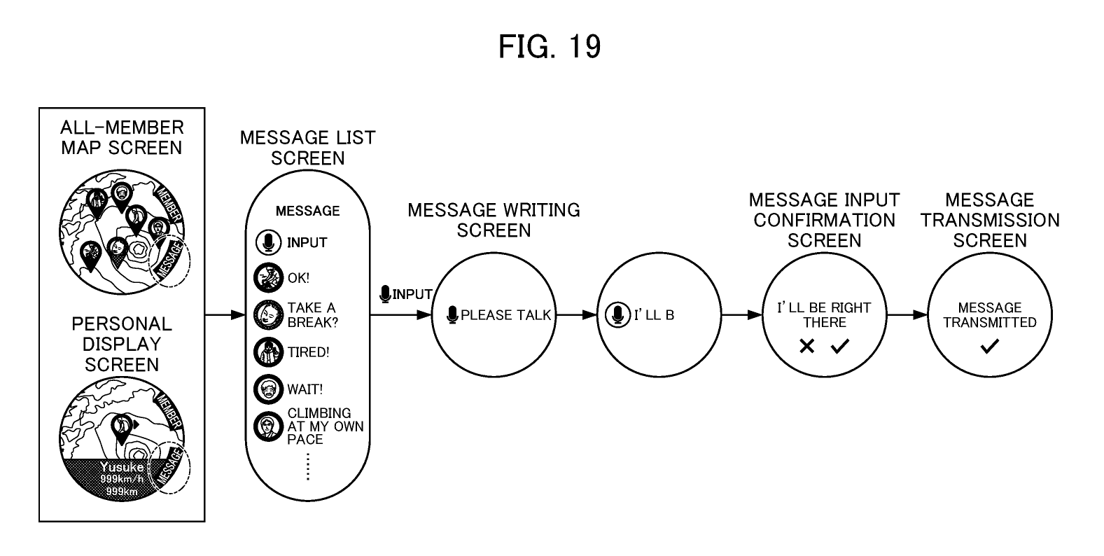

FIG. 19 is a schematic diagram illustrating a transition example of a screen display for sending a message.

As illustrated in FIG. 19, by tapping a “MESSAGE” button displayed on the all-member map screen or the personal display screen, a message transmission can be performed.

By tapping the “MESSAGE” button, the screen transitions to a message list screen, on which the user can check the messages sent to each member up to the present time, input various messages (not illustrated), or display the list of message templates. By tapping an “input” icon, the screen transitions to a voice-input screen; and when the user inputs voice while this screen is displayed, a voice input result is displayed as text. Subsequently, the screen transitions to a screen for confirming whether the message displayed should be transmitted, then the message will be transmitted. Note that the message can be transmitted to an individual member, or all of the members, or a plurality of specific members.

The group operation system S as thus configured includes the server 2 and the other mobile terminal 1 having a communication function. The server 2 is connected in communication with each of the mobile terminal 1, and manages information exchange with the mobile terminal 1.

The mobile terminal 1 has the communication control unit 52.

The communication control unit 52 controls the communication unit 21-1 to transmit identification information of the user's terminal to the server 2.

The server 2 has the communication control unit 91 and the group management processing unit 92.

The communication control unit 91 controls the communication unit 21-2 to acquire each identification information of the mobile terminal 1 from the mobile terminal 1 via the communication function of the mobile terminal 1.

The group management processing unit 92 associates the identification information acquired, and groups the plurality of mobile terminal 1. In the state where the server 2 has associated the identification information of the user's terminal with the identification information of the other devices, the group management processing unit 92 constantly provides the users with an interface for transmitting an association cancellation request to the server 2.

As a result, the mobile terminal 1 can associate the identification information acquired, group the plurality of mobile terminal 1, and cancel the association (withdraw from the group, or dissolve the group); therefore, the mobile terminal 1 can create or cancel a temporary group without the need of complicated operations.

The mobile terminal 1 further has the output unit 19-1.

The group management processing unit 92 causes the output unit 19-1 to constantly display a group cancellation icon as an interface for association cancellation.

As a result, the users of the mobile terminal 1 can always be conscious of the capability of group cancellation.

The mobile terminal 1 has the input unit 18-1.

The group management processing unit 92 sets up a user's predetermined swiping operation on the input unit 18-1, as an interface for association cancellation.

As a result, the user of the mobile terminal 1 can cancel the association through an intuitive and simple operation.

The group management processing unit 92 further sets up an automatic group cancellation condition in accordance with a setup by the user; and the mobile terminal 1 automatically cancels the association, based on the automatic group cancellation condition.

As a result, the mobile terminal 1 can be equipped with the function to automatically withdraw from a group or dissolve a group upon satisfying a predetermined condition.

After the grouping is completed, the communication control unit 52 controls the communication unit 21-1 to transmit grouping cancellation information for instructing the server 2 to cancel the grouping (group dissolution information) to the server 2.

The group management processing unit 92 determines whether the grouping cancellation information (group dissolution information) is received from the mobile terminal 1.

In the case in which the group management processing unit 92 has determined that the grouping cancellation information (group dissolution information) was received at the group management processing unit 92, the group management processing unit 92 cancels the association of the identification information corresponding to the mobile terminal 1 that has transmitted the grouping cancellation information (group dissolution information), among the plurality of identification information associated by the group management processing unit 92.

As a result, by receiving the grouping cancellation information (group dissolution information), the mobile terminal 1 can cancel the association of the identification information corresponding to the mobile terminal 1; therefore, the mobile terminal 1 can create a temporary group without the need of complicated operations.

The communication control unit 91 further controls the communication unit 21-1 to acquire grouping authorization information for instructing authorization of the grouping (group creation information) from the mobile terminal 1.

Based on grouping authorization information (group creation information), the group management processing unit 92 associates the identification information acquired, and groups the plurality of mobile terminal 1.

As a result, the mobile terminal 1 can group the plurality of mobile terminal 1, based on the grouping authorization information (group creation information); therefore, the mobile terminal 1 can make a temporary group without the need of complicated operations.

The server 2 has the group management processing unit 92.

The communication control unit 91 controls the communication unit 21-2 to acquire predetermined information, which is acquired correspondingly to each identification information of the mobile terminal 1, from the mobile terminal 1.

The group management processing unit 92 determines whether the predetermined information corresponding to each identification information acquired by the communication control unit 91 satisfies a predetermined condition.

When the group management processing unit 92 determines that the predetermined information (in the present embodiment, a gesture) corresponding to the identification information satisfies the predetermined condition, the group management processing unit 92 associates the identification information, and groups the plurality of mobile terminal 1.

As a result, the mobile terminal 1 are grouped when the predetermined information satisfies a condition; therefore, the mobile terminal 1 can create a temporary group without the need of complicated operations.

The communication control unit 91 controls the communication unit 21-2 to acquire location information of the user's terminal transmitted from the mobile terminal 1.

The group management processing unit 92 determines whether a predetermined condition is satisfied, by determining whether the location of the mobile terminal 1 acquired from the location information falls within a predetermined distance range.

As a result, the mobile terminal 1 can be grouped, based on a condition that the locations of the mobile terminal acquired from the location information fall within a distance range; therefore, the mobile terminal 1 can create a temporary group without the need of complicated operations.

The group management processing unit 92 sets up a predetermined distance range, based on an instruction from the mobile terminal 1.

As a result, since the mobile terminal 1 can set up a distance range, the mobile terminal 1 can create a temporary group depending on the situation.

The communication control unit 91 controls the communication unit 21-2 to transmit the number of groupable mobile terminal 1 to the mobile terminal 1.

As a result, the mobile terminal 1 can create a temporary group with a predetermined number of mobile terminal 1.

The communication control unit 91 further controls the communication unit 21-2 to acquire grouping closure information for instructing closure of the grouping (group invitation closing information) from the mobile terminal 1.

When the group management processing unit 92 receives the grouping closure information (group invitation closing information) transmitted from the mobile terminal 1, the group management processing unit 92 associates the identification information obtained by this point in time, and groups the plurality of mobile terminal 1.

As a result, the mobile terminal 1 can create a temporary group at the point in time when the grouping closure information (group invitation closing information) is received.

The mobile terminal 1 are connected in communication with the server 2; and the plurality of mobile terminal 1 exchange information with one another.

The communication control unit 52 controls the communication unit 21-1 to transmit the identification information of the user's terminal to the server 2.

The communication control unit 52 associates the identification information of the user's terminal and the identification information of the other mobile terminal 1 on the server 2; and the communication control unit 52 controls the communication unit 21-1 to transmit the grouping authorization information for authorizing the grouping of the plurality of mobile terminal 1 (group joining information).

As a result, the mobile terminal 1 can create a temporary group without the need of complicated operations.

The group setup processing unit 51 acquires predetermined information of the terminal (in the present embodiment, gesture information).

When the communication control unit 52 has determined that the predetermined information (in the present embodiment, gesture information) satisfies a predetermined condition, the communication control unit 52 associates the identification information, and controls the communication unit 21-1 to transmit the grouping authorization information for grouping the plurality of mobile terminal 1 (group joining information).

As a result, since the mobile terminal 1 can set up predetermined information (in the present embodiment, gesture information), the security, etc. can be improved.

The mobile terminal 1 includes the group setup processing unit 51.

The group setup processing unit 51 controls the GPS unit 16-1 to acquire location information of the user's terminal for determining whether a predetermined condition is satisfied by determining whether the location of the mobile terminal 1 falls within a predetermined distance range.

The communication control unit 52 controls the communication unit 21-1 to transmit the location information acquired by the communication control unit 91 to the server 2.

As a result, the mobile terminal 1 can create a temporary group by using the location information of the user's terminal.

The group setup processing unit 51 sets up a distance range in advance, through a user operation or the like.

As a result, since the mobile terminal 1 can set up a distance range in advance, the mobile terminal 1 can create a temporary group depending on the situation.

The mobile terminal 1 includes the output control unit 53.

In the case in which the server 2 sets up the number of groupable mobile terminal 1, the output control unit 53 controls the output unit 19-1 to report the number of the mobile terminal 1.

As a result, the user of the mobile terminal 1 can recognize the number of the groupable mobile terminal 1.

The communication control unit 52 controls the server 2 to transmit the grouping closure information for instructing closure of the grouping of the plurality of mobile terminal 1 (group invitation closing information).

As a result, since the mobile terminal 1 can close the grouping depending on the situation, the mobile terminal 1 can create a temporary group.

The output control unit 53 controls the server 2 to cause the output unit 19-1 to display a predetermined image corresponding to each identification information associated by this point in time.

As a result, the mobile terminal 1 can display, for example, an image for identifying the user's terminal, in which the image registered by the user indicates the user himself/herself.

The output control unit 53 controls the output unit 19-1 to display predetermined images, such that the order of associating the identification information or the total number information of associating the identification information.

As a result, the mobile terminal 1 can perform display such that the order of associating the identification information or the total number of associating the identification information can be understood.

The communication control unit 52 controls the communication unit 21-1 to acquire the associated location information of the user's terminal and the other mobile terminal 1 from the server 2.

The output control unit 53 controls the output unit 19-1 to report the location information of the user's terminal and/or the other terminal associated based on the location information.

As a result, the mobile terminal 1 can confirm the locations of the user's terminal and the other mobile terminal 1.

The communication control unit 52 controls the communication unit 21-1 to receive a message.

The output control unit 53 controls the output unit 19-1 to report the location information and the message of the user's terminal and the other mobile terminal 1 associated.

As a result, the mobile terminal 1 can confirm the locations of the user's terminal and the other mobile terminal 1 as well as the messages from the other mobile terminal 1, etc.

The communication unit 21-1 performs wireless communication with the other mobile terminal 1.

The communication control unit 52 transmits the identification information of the user's terminal to the server 2, based on the state of wireless communication of the communication unit 21-1.

As a result, the mobile terminal 1 can transmit, for example, the identification information of the user's terminal, including the state of wireless communication with the other mobile terminal 1, to the server 2; and the mobile terminal 1 can transmit the identification information of the user's terminal, regardless of whether the communication state is favorable or deteriorated.

It should be noted that the present invention is not to be limited to the above-mentioned embodiment, and that modifications, improvements, etc. within a scope that can achieve the objects of the present invention are also included in the present invention.

In the above-mentioned embodiment, sharing location information is described as an example of the function to share information within a group; however, the present invention is not limited thereto. For example, an embodiment may be configured to exchange data or instant messages between terminals.

Moreover, the above-mentioned embodiment is configured to delete group information or cancel association when dissolving a group or withdrawing from a group; however, an embodiment may be configured to invalidate the group information or invalidate particular association.

In addition, the above-mentioned embodiment may be configured to arbitrarily set up the maximum number of people to join a group. For example, the parent mobile terminal 1A may be configured to set up the maximum number of people through a user operation. Further, the invitation may be automatically closed when a predetermined number of people have joined. In this case, the invitation may be automatically closed, upon satisfying conditions such as the minimum number of people have joined and a predetermined time period has elapsed.

Moreover, the above-mentioned embodiment is configured to operate management of a group via the server 2; however, the present invention is not limited thereto, and an embodiment may be configured to manage a group by a terminal alone (for example, the parent's terminal).

In addition, in the above-mentioned embodiment, the same location range is set up as an area range; however, for example, the same atmospheric pressure/altitude, the same language, the same setup, etc. may be set up as an area range. In this case, for example, in the case of using the same atmospheric pressure/altitude, the same setup, or the like, an embodiment may be configured to dissolve a group or withdraw from a group when the originally set up state is changed.

Further, in the above-mentioned embodiment, an area range is configured as a range of location information acquired by way of GPS; however, an area range may be configured as, for example, a range in which near field communication such as Bluetooth® or LowEnergy can be performed. Moreover, an area range may be configured as a range in which a beacon can be communicated. Specifically, in the case of operations by way of a beacon, a beacon ID of the user's terminal and a corresponding unique ID of the user's terminal are registered in association with each other on the server 2, and when a beacon is received, the beacon ID of the received beacon is uploaded to the server 2. This may be configured such that the server determines whether the beacon ID and the corresponding unique ID are registered, and in the case in which the IDs are registered, the mobile terminal 1 of the unique ID corresponding to the received beacon ID is considered to be located closely to the mobile terminal 1 of the unique ID of the user's terminal, and both of the mobile terminals 1 are treated as a group so as to deliver information, etc.

In addition, the above-mentioned embodiment is configured such that a user arbitrarily dissolves a group or withdraws from a group; however, an embodiment may be configured to automatically dissolve a group or withdraw from a group when, for example, the distance between the group members increases, or the group members leave a predetermined range, in a spatial manner. Further, an embodiment may be configured to automatically dissolve a group or withdraw from a group, when a predetermined time period has elapsed, or a predetermined time has come, in a temporal manner. Moreover, for example, an embodiment may be configured such that, even if a member has withdrawn from a party by leaving a location range, the member is allowed to rejoin the party upon satisfying the condition again.

In addition, in terms of security as well, the above-mentioned embodiment is configured to allow a person to join a group on condition of performing a gesture designated by the parent; however, an embodiment may be configured to allow a person to join a group on condition of being present at a predetermined place, or on a further complicated condition or a plurality of conditions added.

Further, in the above-mentioned embodiment, an area range is set up, and when the mobile terminal in the area range satisfies a predetermined condition, the mobile terminal 1 in the area range is allowed to join the group; however, without setting up an area range in particular, the mobile terminal 1 may be allowed to join the group by simply satisfying a predetermined condition such as a gesture designated by the parent.

Moreover, the above-mentioned embodiment effectively functions in cases such as when an outdoor activity is performed, and when an area of activities is fixed in advance, such as a business trip or exhibition, or a trip involving activities as a group. In addition, in the above-mentioned embodiment, information is shared via the server 2, and is not directly exchanged between the terminals; therefore, the embodiment is free from worry about information leak, etc., and the users can have a sense of security in joining a group with unspecified members.

Further, the above-mentioned embodiment may be configured to allow the parent mobile terminal 1A or the child mobile terminal 1B to perform various setups in an arbitrary/automatic manner, or may be configured to allow the server 2 to perform various setups in an arbitrary/automatic manner.

Moreover, in the above-mentioned embodiment, a smartphone or smartwatch is described as an example of the mobile terminal 1, to which the present invention is applied; however, the present invention is not limited thereto, in particular.

For example, the present invention can be applied to electronic devices, in general, having a group operation processing function. Specifically, for example, the present invention is applicable to notebook personal computers, printers, television receivers, video cameras, digital cameras, portable navigation devices, cellular phone handsets, portable gaming machines, etc.

In addition, the mobile terminal 1 may further include a separately-provided display unit connected in communication with the mobile terminal 1, in which the display unit may perform various displays.

The processing sequence described above can be executed by way of hardware, and can be executed by way of software as well.

In other words, the functional configuration of FIG. 8 merely illustrates an example, and is not limited in particular. That is, as long as the mobile terminal 1 has a function capable of executing the above-mentioned sequence of processing as a whole, what type of functional blocks should be used to implement this function is not limited to the example of FIG. 8, in particular.

A single functional block may be configured with a single piece of hardware, a single installation of software, or a combination thereof.

The functional configurations in the present embodiment are realized by way of a processor for performing arithmetic processing; and a processor usable for the present embodiment includes a processor configured with a single unit of various types of processing units, such as a single processor, a multiprocessor, and a multi-core processor, as well as a combination of such various types of processing units with processing circuits such as ASIC (Application Specific Integrated Circuit) or FPGA (Field-Programmable Gate Array).

In the case in which a sequence of processing is executed by way of software, a program configuring the software is installed from a network or a storage medium into a computer or the like.

The computer may be a computer embedded in dedicated hardware. Moreover, the computer may be a computer capable of executing various functions by installing various programs, e.g., a general-purpose personal computer.

The storage medium containing such a program not only can be constituted by the removable medium 31 illustrated in FIGS. 6 and 7 which is distributed separately from the device main body in order to supply the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray® or the like. The magnetic optical disk is composed of an MD (Mini-Disk) or the like. The storage medium supplied to the user in a state incorporated in the device main body in advance may include, for example, the ROM 12 illustrated in FIGS. 6 and 7, a hard disk included in the storage unit 20 illustrated in FIGS. 6 and 7 or the like, in which the program is recorded.

It should be noted that, in the present specification, the steps defining the program recorded in the storage medium include not only the processing executed in a time series following this order, but also processing executed in parallel or individually, which is not necessarily executed in a time series.

In addition, in the present specification, the term ‘system’ shall mean a general device configured with a plurality of devices, a plurality of means, and the like.

The embodiment of the present invention described above is only illustrative, and is not to limit the technical scope of the present invention. The present invention can assume various other embodiments. Additionally, it is possible to make various modifications thereto such as omissions or replacements within a scope not departing from the spirit of the present invention. These embodiments or modifications thereof fall within the scope and the spirit of the invention described in the present specification, and fall within the scope of the invention recited in the claims and equivalents thereof.

What is claimed is:

1. A terminal being connected in communication with a server, and exchanging information with other terminal, the terminal comprising a processor, wherein the processor executes:
an identification information transmission processing of transmitting identification information of a user's terminal to the server;
a grouping authorization information transmission processing of transmitting grouping authorization information for associating the identification information of the user's terminal with identification information of the other terminal on the server, and allowing a plurality of terminals to be grouped; and
a grouping cancellation processing of constantly providing users with an interface for transmitting cancellation of the association to the server, in a state where the identification information of the user's terminal is associated with the identification information of the other terminal on the server.

2. The terminal according to claim 1, wherein
the terminal further includes a first display unit, and
the grouping cancellation processing causes the first display unit to constantly display a group cancellation icon as the interface for transmitting cancellation of the association.

3. The terminal according to claim 1, wherein
the terminal includes a pressure sensor unit, and
the grouping cancellation processing of setting up a predetermined swiping operation on the pressure sensor unit by the user, as the interface for transmitting cancellation of the association.

4. The terminal according to claim 1, wherein
the grouping cancellation processing further includes a group cancellation condition setup processing of setting up an automatic group cancellation condition in accordance with a setup by the user, and
the terminal automatically cancels the association, based on the automatic group cancellation condition.

5. The terminal according to claim 1, further comprising:
an information acquisition processing of acquiring predetermined information of the terminal; and
a predetermined information transmission processing, wherein in a case in which the predetermined information satisfies a predetermined condition, predetermined information transmission processing transmits the grouping authorization information for allowing the plurality of terminals to be grouped by associating the identification information.

6. The terminal according to claim 5, further comprising:
a location information acquisition processing of acquiring location information of the user's terminal for determining whether the predetermined condition is satisfied by determining whether the terminal exists at a location within a predetermined distance range; and
a location information transmission processing of transmitting the location information acquired by the location information acquisition processing to the server.

7. The terminal according to claim 6, further comprising:
a distance range setup processing of setting up the distance range in advance.

8. The terminal according to claim 1, further comprising:
a report processing of reporting a number of terminals in a case in which the server sets up the number of groupable terminals.

9. The terminal according to claim 1, further comprising:
a grouping closure information transmission processing of transmitting grouping closure information for instructing closure of the grouping of the plurality of terminals.

10. The terminal according to claim 1, further comprising:
a second display unit; and
a display control unit that causes the second display unit to display a predetermined image corresponding to each of the identification information associated by this point in time on the server.

11. The terminal according to claim 10, wherein
the display control processing causes the second display unit to display the predetermined image, such that an order of associating the identification information or a total number information of associating the identification information.

12. The terminal according to claim 1, further comprising:
a location information acquisition processing of acquiring location information of the user's terminal and the other terminal associated, from the server; and
a report processing of reporting the location information of the user's terminal and/or the other terminal associated based on the location information.

13. The terminal according to claim 12, further comprising:
a message reception processing of receiving a message, wherein
the report processing reports the location information and the message of the user's terminal and the other terminal associated.

14. The terminal according to claim 1, further comprising:
a terminal-to-terminal wireless communication processing of performing wireless communication with the other terminal, wherein
the identification information transmission processing transmits identification information of the user's terminal to the server, based on a state of the wireless communication of the terminal-to-terminal wireless communication processing.

15. A server being connected in communication with terminals, and managing information exchange with the terminals, the server comprising a processor, wherein the processor executes:
an information acquisition processing of acquiring each identification information of the terminals from the terminals via a communication function of the terminals;
a grouping processing of grouping the plurality of terminals by associating the identification information acquired by the information acquisition processing; and
a grouping cancellation processing, wherein in a case in which an instruction to cancel the association is received from one of the plurality of associated terminals via an association cancellation interface that is constantly provided to users, the grouping cancellation processing of cancelling the association of the plurality of terminals.

16. A system comprising:
a plurality of terminals having a communication function; and
a server being connected in communication with the terminals, and managing information exchange with the terminals,
wherein the terminals execute:
an information transmission processing of transmitting identification information of the user's terminal to the server;
a grouping cancellation information transmission processing of constantly providing users with an interface for transmitting cancellation of the association to the server, in a state where the identification information of the user's terminal is associated with the identification information of the other terminal on the server; and
wherein the server executes:
an information acquisition processing of acquiring each identification information of the terminals from the terminals via a communication function of the terminals;
a grouping processing of grouping the plurality of terminals by associating the identification information acquired by the information acquisition processing; and
a cancellation determination processing of determining whether cancellation of the association has been received from the terminals; and
a grouping cancellation processing, wherein in a case in which the cancellation determination processing determines that cancellation of the association has been received, the grouping cancellation processing cancels the association of the identification information corresponding to the terminal that has transmitted the cancellation of the association, among the plurality of identification information associated by the grouping processing.

17. A management method performed on a terminal being connected in communication with a server and sharing information with other terminal, the method comprising:
an identification information transmitting step of transmitting identification information of a user's terminal to the server;
a grouping authorization information transmitting step of transmitting grouping authorization information for allowing a plurality of terminals to be grouped by associating the identification information of the user's terminal and identification information of the other terminal on the server; and
a grouping cancellation step of constantly providing users with an interface for transmitting cancellation of the association to the server, in a state where the identification information of the user's terminal is associated with the identification information of the other terminal on the server.

18. A non-transitory computer-readable medium having a program recorded thereon for causing a computer to control a terminal being connected in communication with a server and sharing information with other terminal to function as:
an identification information transmission unit that transmits identification information of a user's terminal to the server;
a grouping authorization information transmission unit that transmits grouping authorization information for allowing a plurality of terminals to be grouped by associating the identification information of the user's terminal and identification information of the other terminal on the server; and
a grouping cancellation unit that constantly provides users with an interface for transmitting cancellation of the association to the server, in a state where the identification information of the user's terminal is associated with the identification information of the other terminal on the server.
